(19) United States
(12) Patent Application Publication
(10) Pub. No.: US 2006/0095160 A1
(43) Pub. Date: May 4, 2006

(54) Robot controller

(75) Inventors: Atsuo Orita, Wako-shi (JP); Naoaki Sumida, Wako-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: HONDA MOTOR CO., LTD.

(21) Appl. No.: 11/261,775

(22) Filed: Oct. 31, 2005

(30) Foreign Application Priority Data
Nov. 2, 2004 (JP) 2004-319287

(51) Int. Cl. G05B 19/418

(52) U.S. Cl. 700/248

(57) ABSTRACT

Disclosed is a robot controller which includes a map acquisition unit for obtaining map data on an active area where the routes are formed, a current location acquisition unit for obtaining current location data on current locations of the robots, a sub-goal acquisition unit for obtaining sub-goal data on sub-goals created on the routes, a collision possibility determination unit for determining whether two robots are likely to collide, a moving route change instruction unit for generating a moving route changing instruction signal, the moving route changing instruction signal for allowing at least one of the two robots to change its route, and a sending device for transmitting the moving route changing instruction signal to the corresponding one of the two robots. In this controller, the robots are controlled such that they move around without causing collisions.

### CROSS-REFERENCE TO RELATED APPLICATIONS

This application claims the benefit of Japanese Patent Application 2004-319287 filed on Nov. 2, 2004, the disclosure of which is incorporated herein by reference.

### BACKGROUND OF THE INVENTION

1. Field of the Invention

Generally, the present invention relates to robot controllers for multiple mobile robots. More specifically, the present invention is directed to a robot controller that allows multiple mobile robots to move around without colliding with one another.

2. Description of the Related Art

To allow multiple autonomous mobile robots to execute tasks, a robot controller is necessary. Upon control, since multiple mobile robots move around within a given area, a robot controller needs to manipulate the robots such that they do not collide with one another. To avoid the collision, the following two techniques have been disclosed.

The first technique (Japanese Unexamined Patent Application Publication 5-66831) discloses a system which allows mobile robots to detect nodes on their routes. When one robot detects a node, it sets the detected node as a destination. Subsequently, the robot sends a moving request to a control section of the system. Upon receipt of this request, the control section determines whether to accept it. If the request is permitted, the robot moves to the destination.

The second technique (Japanese Unexamined Patent Application Publication 8-63229 or U.S. Pat. No. 5,652,489) discloses mobile robots which communicate with one another. When robots are likely to collide, they step aside from one another robot through the communication.

However, as for the system of the first technique, the earlier request has a higher priority than that of the later one. Therefore, tasks are not executed in order of priority. Actually, a mobile robot that needs to execute a higher-priority task may not be able to acquire the permission from the control section, that is, may not be able to execute the task, although the robot is not likely to collide. Thus, the movement of the mobile robots is not optimized. In addition, due to the fact that the moving request is always necessary in order for the mobile robots to move, the communication process between each robot and the control section ends up complex.

As for the mobile robots of the second technique, the robots are not adaptable to the change in the priority of the task. This may inhibit the robots from moving appropriately without causing collisions. Moreover, since the motion of the robots is based on routine motions having been set beforehand, it is impossible for the robots to move flexibly with the geographic features on their moving area.

To overcome the above disadvantages, the present invention has been conceived. An object of the present invention is to present a robot controller which allows multiple mobile robots to move around without causing collisions, by changing the moving routes of the robots only as necessary without affecting the normal movement of the robots.

### SUMMARY OF THE INVENTION

According to an aspect of the present invention, there is provided, a robot controller for communicating with a plurality of mobile robots moving on their routes, including:

(a1) a map acquisition unit for obtaining map data on an active area where the routes are formed;

(a2) a current location acquisition unit for obtaining current location data on current locations of the robots;

(a3) a sub-goal acquisition unit for obtaining one or more pieces of sub-goal data on one or more sub-goals created on each of the routes;

(a4) a collision possibility determination unit for determining whether or not two robots out of the robots are likely to collide with each other, based on the sub-goal data;

(a5) a moving route change instruction unit for generating a moving route changing instruction signal, based on the map data, the current location data and the sub-goal data, the moving route changing instruction signal for allowing at least one of the two robots to change its route; and

(a6) a sending device for transmitting the moving route changing instruction signal to the corresponding one of the two robots.

In this controller, the robots are controlled such that they move around without causing collisions.

According to another aspect of the present invention, there is provided, a robot control system, including:

(b1) a plurality of mobile robots moving within an active area;

(b2) a base station being connected to the robots through radio communication;

(b3) the above robot controller being connected to the base station;

(b4) a network; and

(b5) one or more terminals connected to the robot controller through a network.

According to further another aspect of the present invention, there is provided, a process for controlling a plurality of mobile robots moving on their routes by using a robot controller in such a way that the robots do not collide with one another, the robot controller communicating with the robots, the process including the steps of:

(c1) obtaining map data on an active area where the routes are formed;

(c2) obtaining current location data on current locations of the robots;

(c3) obtaining one or more pieces of sub-goal data on one or more sub-goals created on each of the routes;

(c4) determining whether or not two robots out of the robots are likely to collide with each other, based on the sub-goal data;

(c5) generating a moving route changing instruction signal, based on the map data, the current location data and the sub-goal data, the moving route changing instruction signal for allowing at least one of the two robots to change its route; and

(c6) transmitting the moving route changing instruction signal to the corresponding one of the two robots.

Other aspects, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a view depicting a configuration of a robot control system according to one embodiment of the present invention;

FIG. 2 is a block diagram of each of the robots shown in FIG. 1;

FIG. 3 is a schematic view depicting sub-goals for the robot;

FIG. 4 is a block diagram of the robot controller shown in FIG. 1;

FIG. 5 is a graph used to the approaching determination of the robots;

FIG. 6 is a block diagram of the collision possibility determination unit shown in FIG. 4;

FIG. 7 is a view depicting the sub-goals before and after the interpolation;

FIG. 8 is a block diagram of a moving route change instruction unit shown in FIG. 4.

FIG. 9 is a schematic view depicting the escape and avoidance operation of the two robots;

FIG. 10 is a schematic view depicting the escape and avoidance operation of the two robots;

FIG. 11 is a schematic view depicting the escape and avoidance operation of the two robots;

FIG. 12 is a schematic view depicting the escape and avoidance operation of the two robots;

FIG. 13 is a flowchart of the operations of the robots and of the robot controller for preventing the collision of the robots;

FIG. 14 is a flowchart of the operation of the robot controller;

FIG. 15 is a flowchart of the operations of an approaching determination unit and of a collision possibility determination unit.

FIG. 16 is a schematic view for explaining a process in which an escape location generation sub-unit generates the escape location of the lower priority robot;

FIG. 17 is a flowchart of the process in which an escape location generation sub-unit generates the escape location;

FIG. 18 is a schematic view for explaining how to set two escape location candidates;

FIG. 19 is a schematic view for explaining how to set two escape location candidates;

FIG. 20 is a schematic view for explaining how to set two escape location candidates;

FIG. 21 is a schematic view for explaining how to set two escape location candidates;

FIG. 22 is a schematic view for explaining how to set two escape location candidates;

FIG. 23 is a schematic view for explaining how to set two escape location candidates;

FIG. 24 is a schematic view for explaining how to set two escape location candidates;

FIG. 25 is a schematic view for explaining how to set two escape location candidates;

FIG. 26A is a view for explaining the escape and avoidance operations of the robot when the number of escape location candidates is four, in the case where the candidates are rotated;

FIG. 26B is a view for explaining the escape and avoidance operations of the robot when the number of escape location candidates is four, in the case where the candidates are not rotated;

FIG. 27 is a schematic view of a process in which the avoidance position generation sub-unit generates the escape locations of the higher priority robot; and

FIG. 28 is a flowchart of a process in which the avoidance position generation sub-unit generates the avoidance locations.

### DETAILED DESCRIPTION OF THE EXEMPLARY EMBODIMENTS OF THE INVENTION

A detailed description will be given below, of a robot controller according to one embodiment of the present invention, with reference to accompanying drawings. In one embodiment, a robot controller is used to manipulate robots working at a front desk in a company, etc., but the present invention is not limited thereto. In the following description, the same reference numerals are given to the same parts, and duplicate description thereof is omitted.

(Configuration of Robot Control System A)

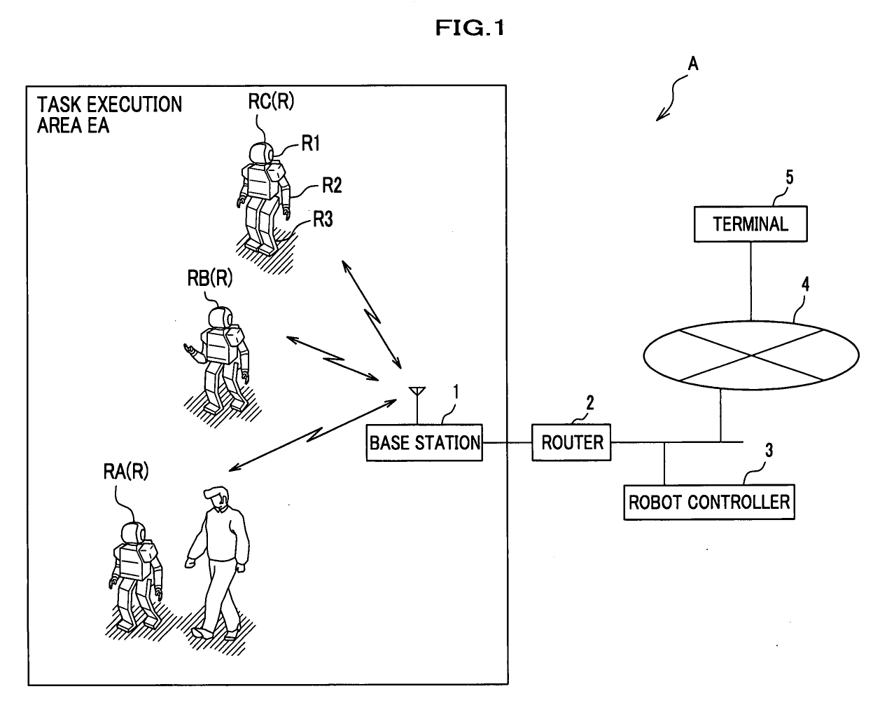

First, a description will be given below, of a robot control system according to one embodiment of the present invention. Referring to FIG. 1, in a robot control system A, a robot controller 3 sends, to one robot R, an executable instruction signal for executing a task. Subsequently, the robot R receives the signal, and then executes the task.

As shown in FIG. 1, the robot control system A includes:

(1) multiple (three in this embodiment) robots RA, RB, and RC arranged within a task execution area EA;

(2) a base station (for example, wireless LAN) 1 connected to the robots RA, RB, and RC through radio communication;

(3) the robot controller (for example, server) 3 connected to the base station 1 through a router 2; and

(4) a terminal 5 connected to the robot controller 3 through a network (LAN) 4.

Herein, the robots RA, RB and RC refer to mobile robots, and the task execution area EA refers to an active area.

The robots RA, RB and RC are arranged within the task execution area EA, and they have a function of moving autonomously and executing tasks.

In the following description, when any one of the robots RA, RB and RC is mentioned, it is simply called “robot R”.

The base station 1 is placed within the task execution area EA, and it has a function of communicating with the robots RA, RB and RC.

A detailed description will be given below, of the individual configurations of the robot R and the robot controller 3.

[Robot R]

The robot R according to the embodiment of the present invention is an autonomous type of bipedal mobile robot. This robot R receives the executable instruction signal from the robot controller 3, and then executes a task, based on the received instruction.

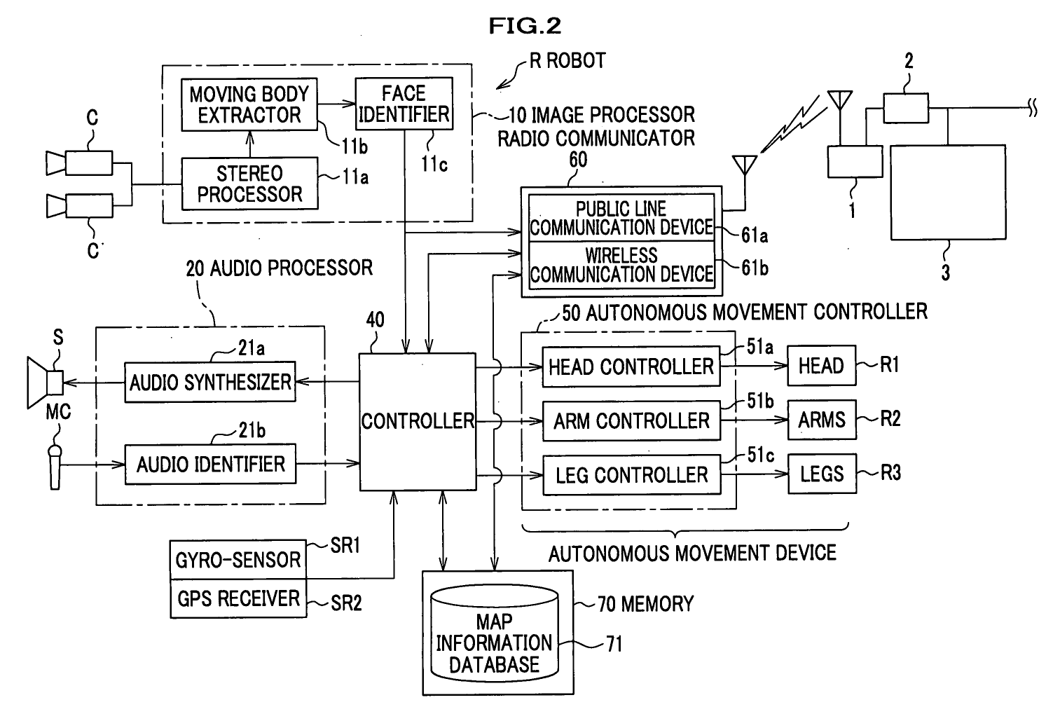

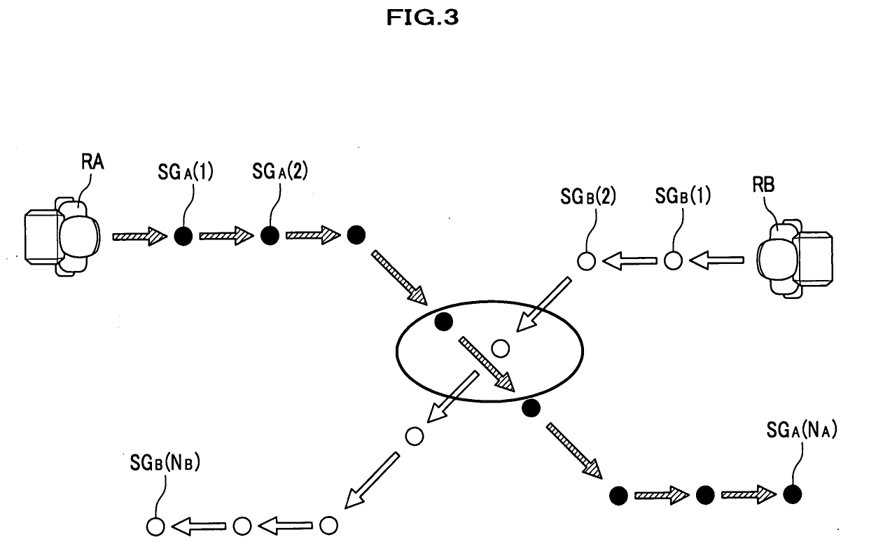

As shown in FIG. 1, the robot R is equipped with a head R1, arms R2 and legs R3. They are driven by an actuator, and the bipedal movement is controlled by an autonomous movement controller 50 (see FIG. 2). The detail of the bipedal movement has been disclosed by Japanese Unexamined Patent Application Publication 2001-62760, etc.

Referring to FIG. 2, the robot R includes cameras C, C, a speaker S, a microphone MC, an image processor 10, an audio processor 20, a controller 40, an autonomous movement controller 50, a radio communicator 60, and a memory 70, in addition to the head R1, the arms R2 and the legs R3. Furthermore, the robot R includes a gyro-sensor SR1 for detecting its orientation, and a GPS receiver SR2 for detecting its current location. The gyro-sensor SR1 and the GPS receiver SR2 output the detected data to the controller 40. The controller 40 uses the data to determine the action of the robot R, and it sends this data to the robot controller 3 through the radio communicator 60.

[Cameras C, C]

The cameras C, C has a function of capturing images in digital data form, and they may be color CCD (Charge-Coupled Device) cameras. The cameras C, C are arranged horizontally, and output the captured images to the image processor 10. The cameras C, C, the speaker S and the microphone MC are contained in the head R1.

[Image Processor 10]

The image processor 10 has a function of treating the images captured by the cameras C, C, and it recognizes the presence of persons and obstacles around the robot R in order to realize the surrounding conditions. This image processor 10 is composed of a stereo processor 11a, a moving body extractor 11b, and a face identifier 11c.

The stereo processor 11a performs pattern matching by using one of the respective two images captured by the cameras C, C as a reference. Following this, the processor 11a determines the parallaxes between the pixels of one image and the corresponding pixels of the other image, thus generating a parallax image. Finally, it outputs the parallax image and the original images to the moving body extractor 11b. Note that the parallax depends on a distance between the robot R and a captured object.

The moving body extractor 11b takes out one or more moving bodies from the captured image, based on the images from the stereo processor 11a. This action is done to recognize one or more persons, under the condition that a moving object (or body) is a person. To take out a moving body, the moving body extractor 11b memorizes several past frames, and it carries out the pattern matching by comparing the latest frame (or image) with the past frames (or images). As a result, the moving body extractor 11b determines the moving amounts of the pixels, and produces moving amount images. If the moving body extractor 11b checks whether or not there is any pixel with a large moving amount, based on the parallax image and the moving amount image. If the pixel with a large moving amount is found, then the moving body extractor 11b determines that a person is present within an area at a predetermined distance away from the cameras C, C. Following this, the moving body extractor 11b outputs the image of the person to the face identifier 11c.

The face identifier 11c takes out skin-colored portions from the image of the moving body, and recognizes the position of its face, based on the size, shape, etc. of the extracted portions. Similarly, the face identifier 11c recognizes the position of the hands. The face identifier 11c outputs data on the recognized face position to the controller 40 so that the data is used to move or communicate with the owner of the face. Also, it outputs data on the recognized face position to the radio communicator 60, as well as to the robot controller 3 through the base station 1.

[Audio Processor 20]

The audio processor 20 is composed of an audio synthesizer 21a and an audio identifier 21b. The audio synthesizer 21a generates audio data from character information stored beforehand, based on a speech action instruction determined and outputted by the controller 40. Subsequently, the audio synthesizer 21a outputs the generated audio data to the speaker S. Upon generation of the audio data, the relation between the character information and the audio data is used.

The audio identifier 21b generates the character information from the audio database on the relation between the audio data (having been inputted from the microphone MC) and the character information. Subsequently, the audio identifier 21b outputs the generated character information to the controller 40.

[Controller 40]

The controller 40 generates a signal to be sent to a robot controller 3 (described later), and controls the individual components such as the image processor 10, the audio processor 20, an autonomous movement controller 50 and the radio communicator 60, in response to the executable instruction signal from the robot controller 3.

Furthermore, the controller 40 generates robot state data to output it at regular time intervals. The robot state data contains a robot ID, current location data, orientation data and move/stop data, and this data is sent to the robot controller 3 through the radio communicator 60. The current location data indicates the current location (coordinates) of the robot R, and it is acquired from the GPS receiver SR2. The orientation data indicates the orientation of the robot R, and it is acquired from the gyro-sensor SR1. The move/stop data indicates that the robot R is moving or not. This data shows “move” when a leg controller 51c drives the legs R3, while it shows “stop” when the leg controller 51c does not drive the legs R3.

The controller 40 generates sub-goal database on task start location data, task end location data and map data.

Next, a description will be given below, about sub-goals.

Once receiving the executable instruction signal from the robot controller 3, the robot R executes a task. This executable instruction signal contains task end location data about the destination of autonomous movement.

The controller 40 creates a finite number of nodes, that is, sub-goals arranged between a task start location (start point) and a task end location (goal), based on the task end location data, the map data, and the current location data acquired from the GPS receiver SR2. The data on the locations of the sub-goals is represented by the sub-goal data. The sub-goals are created by referring to the map data. Specifically, the sub-goals are formed in such a way that they are arranged at regular intervals within the place where the robot R is movable.

In this embodiment, the map data contains a finite number of nodes arranged on a map in a mesh form. Some of the nodes which the robot R is movable to are set as movable nodes (or nodes). The adjacent movable nodes are linked to each other. Specifically, if the robot R stands on one movable node, then it can move to another node linked to the one node. The controller 40 selects some movable nodes, based on the current location data, the task end location data and the map data of the robot R. Following this, the controller 40 sets the selected movable nodes as the sub-goals.

In this embodiment, the robot RA has NA pieces of sub-goal data SG_{A} (n_{A}), and the NAth sub-goal data SG_{A} (N_{A}) corresponds to the task end location data. In addition, the robot R_{B} has N_{B} pieces of the sub-goal data SG_{B} (n_{B}), and the NBth sub-goal data SG_{B} (N_{B}) corresponds to the task end location data. The robot R keeps moving to the nearest sub-goal until reaching the task end location.

The controller 40 acquires the sub-goal data from the memory 70, in response to a sub-goal request signal from the robot controller 3. The controller 40 sends the acquired sub-goal data to the robot controller 3 through the radio communicator 60.

Moreover, the controller 40 generates an escape start signal. This escape start signal is to inform that the robot R is escaping, in response to an escape instruction signal which the robot R has received. The controller 40 sends the escape start signal to the robot controller 3 through the radio communicator 60.

Furthermore, the controller 40 generates an escape end signal. The escape end signal is to inform that the robot R has escaped, in response to an escape instruction signal which the robot R has receives. The controller 40 compares escape end location data and the current location data outputted from the GPS receiver SR2. If both pieces of data are coincident with each other, then the controller 40 determines that the escape of the robot R has ended. In this case, the controller 40 generates an escape end signal and, then sends it to the robot controller 3 through the radio communicator 60.

[Autonomous Movement Controller 50]

With reference to FIG. 2 again, the configuration of the robot R will be described. The autonomous movement controller 50 is composed of a head controller 51a, an arm controller 51b, and a leg controller 51c. The head controller 51a, the arm controller 51b and the leg controller 51c drive the head R1, the arms R2 and the legs R3, respectively, in accordance with an instruction from the controller 40.

[Radio Communicator 60]

The radio communicator 60 is a communication device that sends/receives data to or from the robot controller 3. The radio communicator 60 is composed of a public line communication device 61a and a wireless communication device 61b. The public line communication device 61a is a wireless communicator using a public line such as a portable phone line or a personal handy phone system (PHS) line. Meanwhile, the wireless communication device 61b is a short-distance wireless communicator such as a wireless LAN in accordance with IEEE802.11b.

The radio communicator 60 selects one among the public line communication device 61a and the wireless communication device 61b, depending on a connection request from the robot controller 3, thereby sending/receiving data to or from the robot controller 3.

[Memory 70]

The memory 70 stores data necessary for controlling the movement of the robot R. The data in the memory 70 can be updated through the radio communicator 60. The memory 70 incorporates a map information database 71 which stores map information on the task execution area EA where the robot R will execute a task. The map information in the map information database 71 is identical to that in a map information database 220. Furthermore, the memory 70 stores the sub-goal data generated by the controller 40.

[Robot Controller 3]

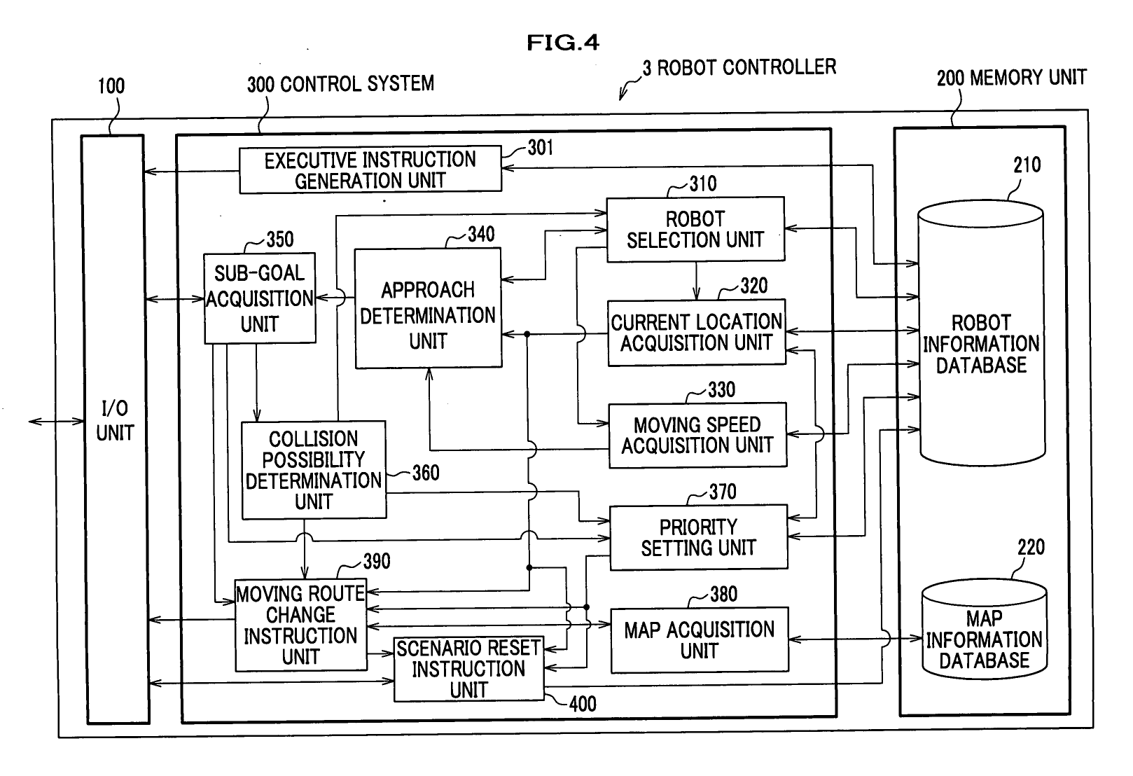

Now, the configuration of the robot controller 3 will be described. Referring to FIG. 4, the robot controller 3 includes an I/O unit 100, a memory unit 200 and a control system 300.

[I/O Unit 100]

The I/O unit 100 is an interface, which sends or receives data to/from the robots R through the base station 1 or to/from the terminal 5 through the network 4. Herein, the I/O unit 100 corresponds to a sending device.

[Memory Unit 200]

The memory unit 200 stores various kinds of data for controlling the robot R. The memory unit 200 is composed of a robot information database 210 and the map information database 220.

[Robot Information Database 210]

The robot information database 210 stores robot data which indicates the states of the robots R, and the robot data is related to the robots R. The robot data contains a robot ID, current location data and moving speed data, and it may further contain information (data) on the size (width), battery's remaining quantity, driving system's condition, etc. of the robot R. The current location data is contained in the robot state data sent from the robot R. The moving speed data indicates the moving speed of the robot R, and it contains speed data and direction data. The moving speed data is generated based on both the move/stop data (contained in the robot state data sent from the robot R) and average moving speed data of the robot R (that is stored beforehand). If the move/stop data shows “moving”, then the average moving speed data is made moving speed data. Otherwise, if the move/stop data shows “not moving”, then the moving speed data is made “0”. The orientation data is contained in the robot state data sent from the robot R. In addition, the robot information database 210 also stores data on tasks which the robot R will execute.

The robot information database 210 stores a collision avoidance list. The collision avoidance list contains a combination of two robots R, which are determined to have a possibility of a collision with each other. The combination is added and registered by the collision possibility determination unit 360, and it is deleted by the scenario reset instruction unit 400.

In the collision avoidance list, the avoidance control state of the robots R is classified into “State 0”, “State 1”, “State 2”, “State 3” and “State 4”. This avoidance control state is set or updated by the control system 300, depending on the collision avoidance control operation of the robot controller 3.

[Map Information Database 220]

The map information database 220 stores map data (global map) on an area where the robots R move around and execute tasks. The map data contains information about aisles, stairs, elevators, rooms, etc. within the area. The robot R can move only within an area permitted by the map data. Furthermore, the map data can be updated by an operator through the terminal 5.

[Control System 300]

The control system 300 includes an executive instruction generation unit 301, a robot selection unit 310, a current location acquisition unit 320, a moving speed acquisition unit 330, an approach determination unit 340, a sub-goal acquisition unit 350, the collision possibility determination unit 360, a priority setting unit 370, a map acquisition unit 380, a moving route change instruction unit 390, and the scenario reset instruction unit 400.

[Executive Instruction Generation Unit 301]

The executive instruction generation unit 301 generates the executable instruction signal for making the robot R execute tasks based on the task data stored in the robot information database 210. The unit 301 sends the generated executable instruction signal to the robot R through the I/O unit 100.

[Robot Selection Unit 310]

The robot selection unit 310 selects two robots R from the multiple robots R. A description will continue, assuming that the robot selection unit 310 selects two robots RA and RB. The robot selection unit 310 outputs the robot IDs of the robots RA and RB to the current location acquisition unit 320 and to the moving speed acquisition unit 330.

[Current Location Acquisition unit 320]

The current location acquisition unit 320 acquires the current location data of the robots RA and RB from the robot information database 210. The unit 320 then outputs the current location data to the approach determination unit 340, and to the moving route change instruction unit 390 as necessary.

[Moving Speed Acquisition Unit 330]

The moving speed acquisition unit 330 acquires the moving speed data of the robots RA and RB from the robot information database 210. The unit 330 then outputs the moving speed data to the approach determination unit 340.

[Approach Determination Unit 340]

The approach determination unit 340 determines whether or not two robots R among multiple robots R are approaching, based on the received current location data and moving speed data.

In this embodiment, the approach determination unit 340 determines whether or not the robots RA and RB having been selected by the robot selection unit 310 are approaching each other.

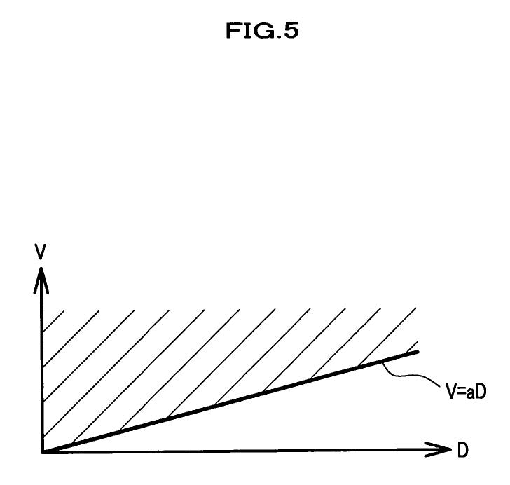

Now, a description will be given below, of a specific process performed by the approach determination unit 340, with reference to FIG. 5.

The approach determination unit 340 determines whether the following relation (1) is satisfied or not:
V≧aD, (1)

where “V”, “D” and “a” stand for the robot approaching speed, the robot distance, and a constant, respectively.

The robot approaching speed V indicates a speed at which the robots RA and RB are approaching each other. It is of a positive value if they are approaching, while it is of a negative value if they are away from each other. The robot approaching speed V is determined based on the orientation data and the average moving speed data (stored already) of the robots RA and RB.

The robot distance D is determined based on the current location data of the robots RA and RB.

The constant “a” is a positive constant and is set beforehand based on the size, etc. of the robots R.

If the relation of the robot approaching speed V and the robot distance D meets the above relation (1), in other words, if the relation thereof falls within a shaded area of a graph of FIG. 5, then the approach determination unit 340 determines that the robots RA and RB are approaching each other. Specifically, the unit 340 determines that the robots RA and RB are approaching each other, if the robot approaching speed V is of a constant value and the robot distance D is equal to/less than a predetermined value (V/a). Also, the unit 340 determines the same, if the robot distance D is of a constant value, and the robot approaching speed V is equal to/more than (aD).

Even if the robot distance D is of a small value, the approach determination unit 340 determines that the robots RA and RB are not approaching as long as the robot approaching speed V is of a negative value.

Every time determining that the robots RA and RB are approaching, the unit 340 outputs the robot IDs of the robots RA and RB to the sub-goal acquisition unit 350. Otherwise, the unit 340 sends, to the robot selection unit 310, a signal indicating that the robots RA and RB are not approaching.

[Sub-goal Acquisition Unit 350]

With reference to FIG. 4 again, the configuration of the robot controller 3 is described. If determining that the robots RA and RB are approaching, the sub-goal acquisition unit 350 acquires the sub-goal data of the robots RA and RB.

The steps of acquiring the sub-goal data are described below briefly.

(1) The sub-goal acquisition unit 350 generates a sub-goal request signal containing the robot IDs of the robots RA and RB.

(2) The unit 350 sends the sub-goal request signal to the robot R through the I/O unit 100.

(3) The sub-goal request signal is received by the robot R. This robot compares its own robot ID and the received robot ID. If both IDs are identical, then the robot sends the sub-goal data to the robot controller 3. In this embodiment, the robots RA and RB send the sub-goal data. The sub-goal data contains the robot ID.

(4) The sub-goal acquisition unit 350 receives the sub-goal data from the robots RA and RB.

(5) The sub-goal acquisition unit 350 outputs the sub-goal data to the collision possibility determination unit 360, and to the priority setting unit 370 as necessary.

[Collision Possibility Determination Unit 360]

The collision possibility determination unit 360 determines whether or not the robots RA and RB will collide with each other, if unit 340 determines that they are approaching.

In this embodiment, the collision possibility determination unit 360 determines it, based on the sub-goal data, the current location data and the moving speed data of the robots RA and RB.

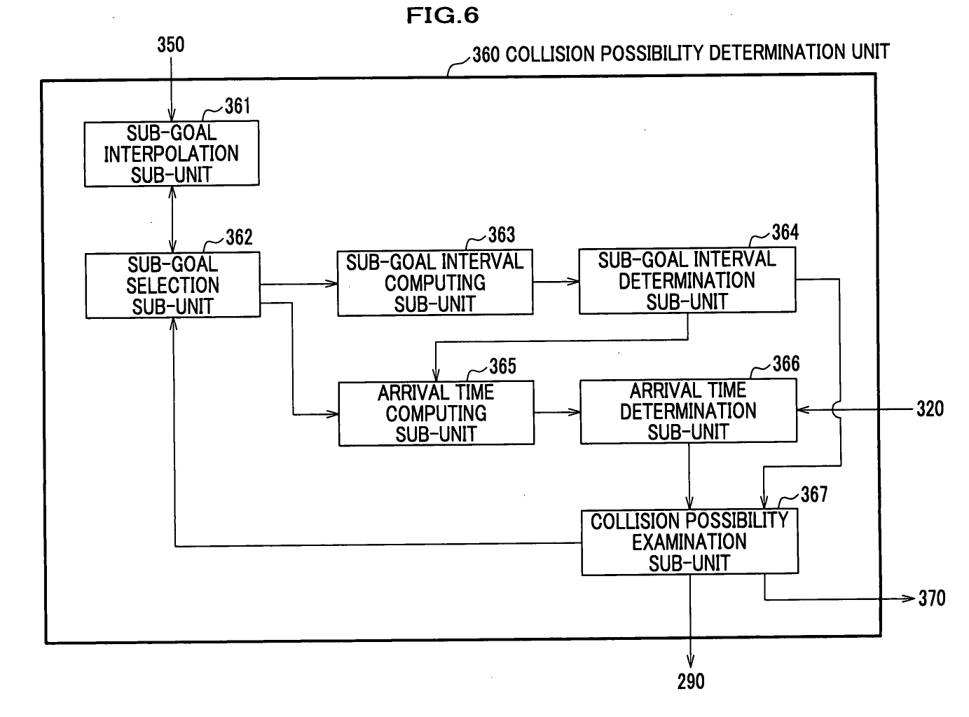

Referring to FIG. 6, the collision possibility determination unit 360 includes a sub-goal interpolation sub-unit 361, a sub-goal selection sub-unit 362, a sub-goal interval computing sub-unit 363, a sub-goal interval determination sub-unit 364, an arrival time computing sub-unit 365, an arrival time determination sub-unit 366 and a collision possibility examination sub-unit 367.

(Sub-Goal Interpolation Sub-Unit 361)

The sub-goal interpolation sub-unit 361 creates new sub-goals between the adjacent sub-goals, based on the received sub-goal data.

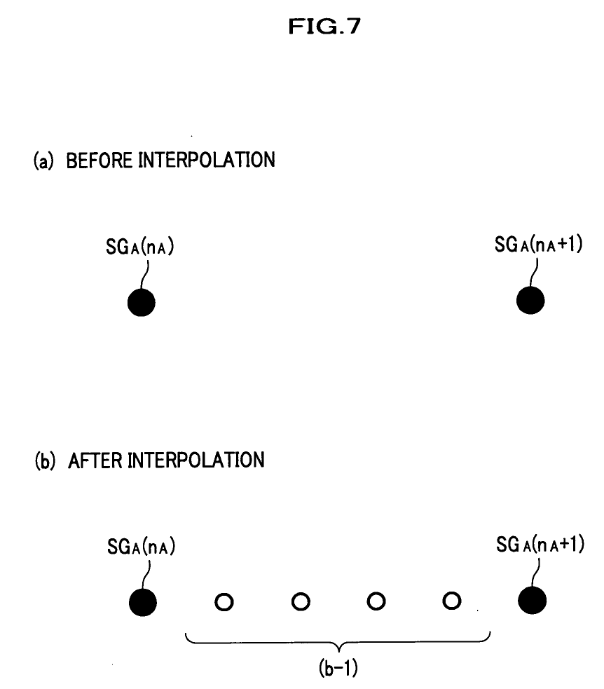

Now, a way how the sub-goals are interpolated will be described. Referring to FIG. 7, the sub-goal interpolation sub-unit 361 generates several pieces of sub-goal data from the received sub-goal data, thereby shortening the distance between the adjacent sub-goals. Thus, as shown in FIG. 7, (b-1) pieces of sub-goals are generated between a sub-goal SG_{A} (n_{A}) and a sub-goal SG_{A} (n_{A}+1), whereby the sub-goal data is interpolated.

The sub-goal through which the robot R has already passed is called “past sub-goal”, while the sub-goal through which the robot R will pass is called “future sub-goal”.

In this embodiment, the interpolation is not performed between the past sub-goals. This is because at each past sub-goal, the collision possibilities do not need to be determined. This decreases the load of the sub-goal interpolation sub-unit 361. However, since there is a possibility of a collision between the past and a next sub-goal, the interpolation is necessary therebetween. The sub-goal interpolation sub-unit 361 outputs the interpolated sub-goal data to the sub-goal selection sub-unit 362. Note that the newly interpolated sub-goal data is used to determine the possibility of the collision, but it is not used to control the movement of the robot R.

The predetermined interpolation number “b” is set in order to ensure a distance enough to determine the collision possibility of the robots and this number is set depending on the distance between the adjacent original sub-goals.

(Sub-Goal Selection Sub-Unit 362)

The sub-goal selection sub-unit 362 of FIG. 6 stores temporarily the sub-goal data interpolated by the sub-goal interpolation sub-unit 361. Furthermore, the sub-goal selection sub-unit 362 selects one piece of sub-goal data on the robot RA and one piece of sub-goal data on the robot RB from the stored data, and it then outputs them to the sub-goal interval computing sub-unit 363 and to the arrival time computing sub-unit 365.

(Sub-Goal Interval Computing Sub-Unit 363)

The sub-goal interval computing sub-unit 363 calculates a distance between the sub-goals, based on the received sub-goal data. Following this, the sub-unit 363 outputs the calculated distance to the sub-goal interval determination sub-unit 364.

(Sub-Goal Interval Determination Sub-Unit 364)

The sub-goal interval determination sub-unit 364 determines whether or not the received distance is equal to/less than a predetermined distance “c”. Note that the distance “c” is set such that the robots RA and RB do not collide with each other, when being placed on the corresponding sub-goals. The sub-unit 364 outputs the determined result to the collision possibility examination sub-unit 367.

In this embodiment, if the distance is equal to/less than a predetermined distance “c”, then the sub-goal interval determination sub-unit 364 outputs a signal indicating that the distance is within the distance “c” to the arrival time computing sub-unit 365.

(Arrival Time Computing Sub-Unit 365)

The arrival time computing sub-unit 365 estimates a time period elapsing until the robots RA and RB reach the selected sub-goals (arrival time). In other words, the sub-unit 365 estimates a time period elapsing until the robots RA and RB shift from the current locations to respective sub-goals.

This time period of the robot RA is estimated based on the current location data, the average moving speed data and the corresponding sub-goal data of the robot RA. Meanwhile, the time period of the robot RB is estimated based on the current location data, the average moving speed data and the corresponding sub-goal data of the robot RB.

In this embodiment, the arrival time computing sub-unit 365 estimates the time periods corresponding to the sub-goals, if the sub-goal interval determination sub-unit 364 determines that the sub-goal is not far away by more than the predetermined distance “c”.

The arrival time computing sub-unit 365 outputs the estimated arrival time to the arrival time determination sub-unit 366.

(Arrival Time Determination Sub-Unit 366)

The arrival time determination sub-unit 366 determines whether or not a difference between the arrival times of the robots RA and RB falls within a predetermined time period “d”. The predetermined time period “d” is set on the basis of the average moving speed of the robot R. The sub-unit 366 outputs the determined result to the collision possibility examination sub-unit 367.

(Collision Possibility Examination Sub-Unit 367)

The collision possibility examination sub-unit 367 determines whether or not the robots RA and RB will collide at the selected respective sub-goals, on the basis of the determined results of the sub-goal interval determination sub-unit 364 and the arrival time determination sub-unit 366.

The sub-unit 367 determines that the robots RA and RB will collide, if the sub-goal interval is within the predetermined distance “c” and the arrival time is within the predetermined time period “d”. Otherwise, the sub-unit 367 determines that the robots will not collide.

If the collision is determined to occur, then the sub-unit 367 outputs, to the priority setting unit 370, a signal indicating that the collision will occur. Otherwise, the sub-unit 367 outputs, to the robot selection unit 310, a signal indicating that the collision will not occur. After that, the robot selection unit 310 selects different combination of the robots R.

[Priority Setting Unit 370]

The priority setting unit 370 compares the respective tasks of the robots RA and RB which have been determined to collide. As a result of the comparison, the unit 370 assigns the respective priority orders to the robots RA and RB.

Now, a description will be given below, of how to determine the priority order.

In this embodiment, the robot control system A allows the robot R to execute a task (i.e. guidance at a front desk). The task of a robot R is classified into five categories <0>, <1>, <2> and <9>.

<0>: idle

<1>: executing task

<2>: pausing task

<9>: urgent

The category <1> is further classified as follows.

<1-1>: guidance task

<1-2>: handover task

<1-5>: reception task

<1-99>: battery exchange

If the above categories are arranged in the priority order, the arrangement is as follows:

<1-1>, <1-2>, <1-99>, <1-5>, <2>, <0> and <9>.

The priority setting unit 370 cannot sometimes assign the priority orders to the robots R, because their tasks may have the same priority. In this case, the priority orders are set such that the robot R that has more future sub-goals obtains the higher priority order. In other words, the priority orders are set such that the robot R that needs to move over longer a distance obtains the higher priority.

In the following description, it is assumed that the robot RB has a higher priority than that of the robot RA. Furthermore, the robot RA is called “lower higher priority robot RA”, and the robot RB is called “higher priority robot RB”.

[Map Acquisition Unit 380]

The map acquisition unit 380 obtains the map data from the map information database 220, and outputs the obtained map data to the moving route change instruction unit 390.

[Moving Route Change Instruction Unit 390]

The moving route change instruction unit 390 generates a moving route changing instruction signal for altering the moving route of at least one of the robots RA and RB, which have been determined to collide. In this embodiment, the moving route changing instruction signal has two types; an escape instruction signal and an avoidance instruction signal. The former is aimed at allowing the lower priority robot RA to escape from the higher priority robot RB. The latter is aimed at allowing the higher priority robot RB to avoid the lower priority robot RA that is escaping.

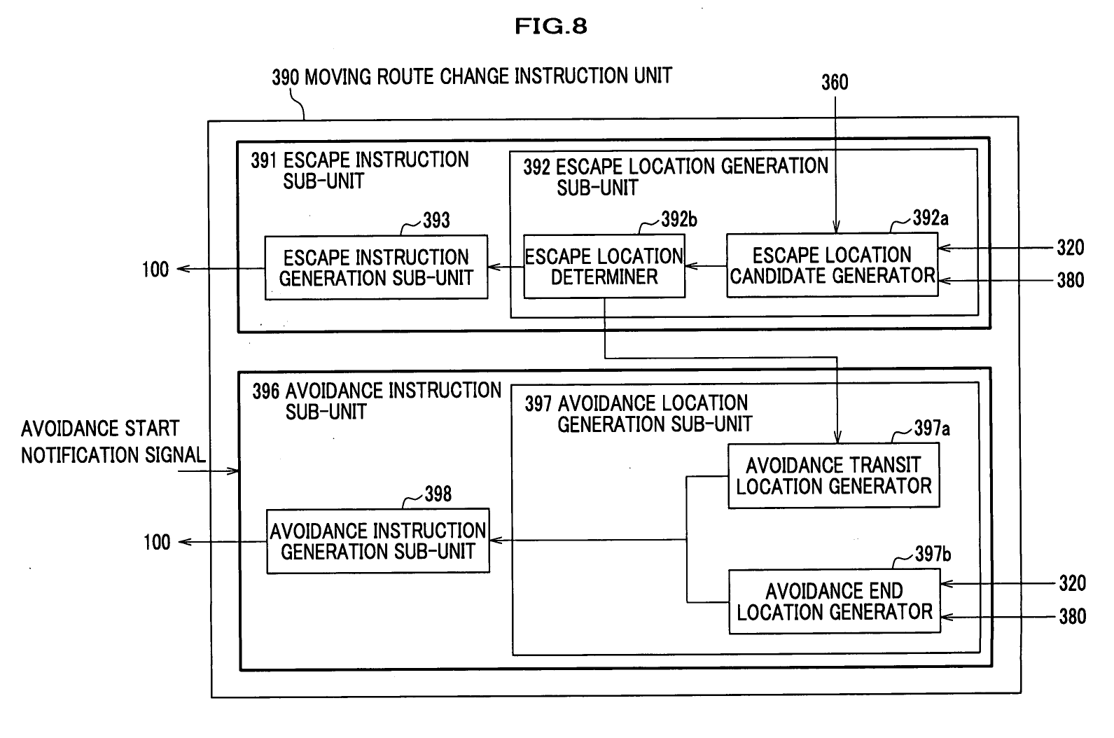

Referring to FIG. 8, the moving route change instruction unit 390 includes an escape instruction sub-unit 391 and an avoidance instruction sub-unit 396. The escape instruction sub-unit 391 generates the escape instruction signal, while an avoidance instruction sub-unit 396 generates an avoidance instruction signal.

The escape instruction signal contains a robot ID and escape location data of the lower higher priority robot RA. The avoidance instruction signal contains a robot ID and avoidance location data of the higher priority robot RB.

(Escape Instruction Sub-Unit 391)

The escape instruction sub-unit 391 generates the escape instruction signal, based on the map data, and the current location data and the sub-goal data of the lower higher priority robot RA. The escape instruction sub-unit 391 includes an escape location generation sub-unit 392 and an escape instruction generation sub-unit 393. In addition, the escape location generation sub-unit 392 is composed of an escape location candidate generator 392a and an escape location determiner 392b.

The escape location candidate generator 392a generates escape candidate location data on where the lower priority robot RA escapes from the higher priority robot RB and waits for passing of the robot RB. The escape location determiner 392b determines the escape location from the escape candidate location data. The escape instruction generation sub-unit 393 generates the escape instruction signal.

The process in which the escape instruction sub-unit 391 determines the escape location will be described later.

[Avoidance Instruction Sub-Unit 396]

The avoidance instruction sub-unit 396 generates an avoidance instruction signal.

The avoidance instruction sub-unit 396 includes an avoidance location generation sub-unit 397 and an avoidance instruction generation sub-unit 398. The avoidance location generation sub-unit 397 is composed of an avoidance transit location generator 397a and an avoidance end location generator 397b.

The avoidance transit location generator 397a generates avoidance transit location data on where the higher priority robot RB passes for the avoidance.

The avoidance end location generator 397b generates avoidance end location data on where the higher priority robot RB terminates the avoidance operation.

The avoidance instruction generation sub-unit 398 generates an avoidance instruction signal for allowing the higher priority robot RB to move to an avoidance end location by way of the avoidance transit locations, based on the avoidance transit location data and the escape end location data.

The process in which the avoidance instruction sub-unit 396 determines an avoidance location will be described later.

[Scenario Reset Instruction Unit 400]

The scenario reset instruction unit 400 generates a scenario reset instruction signal. This signal is aimed at allowing the robot RA that has escaped from the robot RB or the robot RB that has avoided the robot RA to terminate the current operation, and to re-start executing the suspended task. The term of “scenario” means a task which the robot R has suspended in order to perform the escape or avoidance operation. The scenario reset instruction unit 400 sends the scenario reset instruction signal to a corresponding robot R through the I/O unit 100. A detailed description will be given later, of the timing of generating the scenario reset instruction signal.

Now, a description will be given below, of operations in which the robots RA and RB prevent the collision within the task executing area EA.

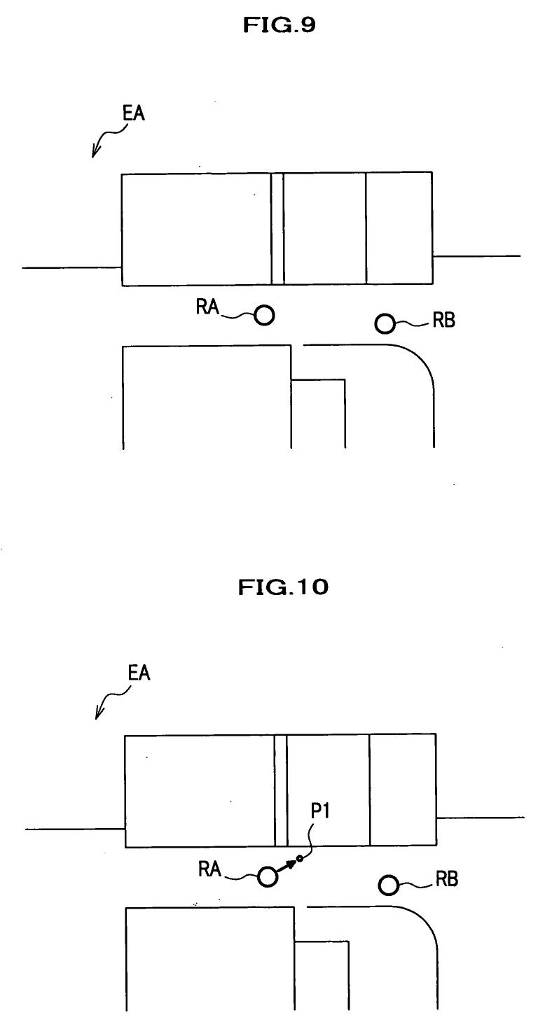

First, referring to FIG. 9, when the robots RA and RB move on a hallway within the task executing area EA, the robot controller 3 (see FIG. 1) determines whether or not the two robots will collide with each other.

Next, referring to FIG. 10, the robot controller 3 generates the escape instruction signal and, then sends it to the robot RA. Upon receipt of this signal, the robot RA moves to an escape location P1 in order to make the robot RB pass through.

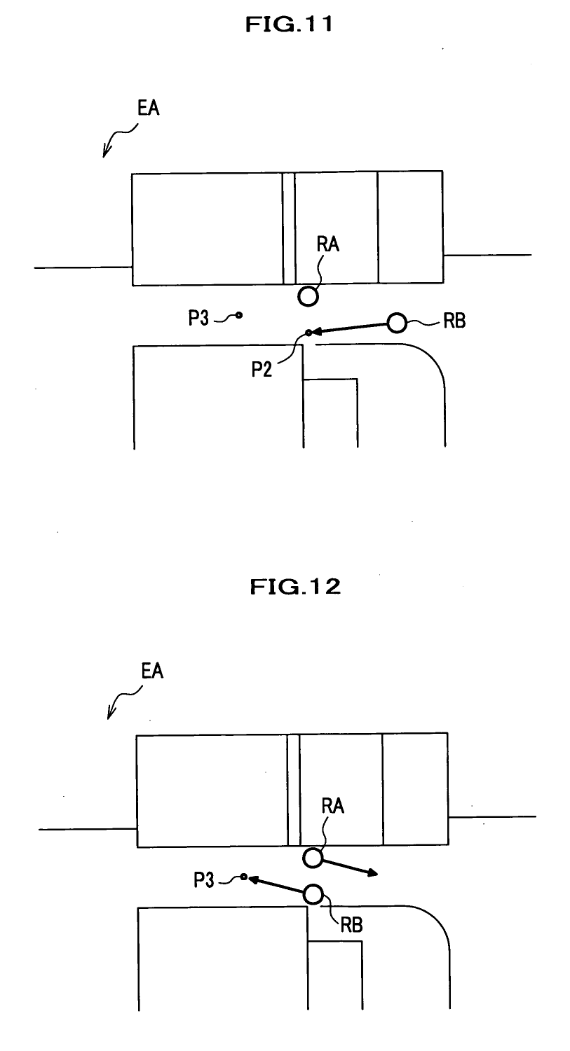

Following this, referring to FIG. 11, the robot controller 3 generates the avoidance instruction signal and, then sends it to the robot RB. Once receiving this signal, the robot RB moves to an avoidance transit location P2, and then, to an avoidance end location P3, so that the robot RB avoids the robot RA.

Referring to FIG. 12, as soon as the robot RB passes through the avoidance transit location P2, the robot RA starts leaving the escape location P1.

<Collision Avoidance Control of Robot Control System A>

A description will be given below, of control under which the robots RA and RB prevent the collision on the task executing area EA.

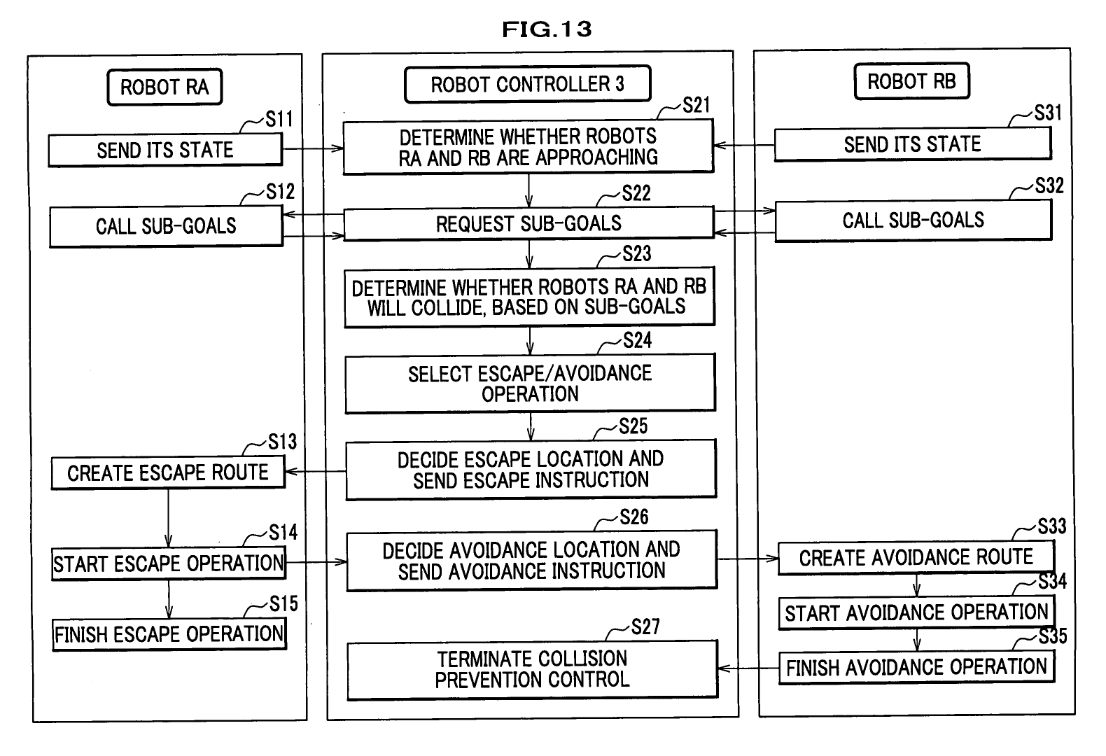

Referring to FIG. 13, the robots R (robots RA and RB) generate respective pieces of robot state data and, then send them to the robot controller 3 at regular time intervals (S11 and S31). The robot controller 3 stores the received pieces of data into the robot information database 210. Provided that another robot RC is present within the task executing area EA, the robot RC carries out the same operations. The robot selection unit 310 selects two arbitrary robots R (the robots RA and RB in this case) from the multiple robots R. The current location acquisition unit 320 acquires the current location data on the robots RA and RB. Furthermore, the moving speed acquisition unit 330 acquires the moving speed data on the robots RA and RB. The current location data and moving speed data are outputted to the approach determination unit 340. Upon receipt of these pieces of data, the approach determination unit 340 determines whether or not the robots RA and RB are approaching each other (S21).

The description will continue, assuming that the robots have been determined to be approaching.

The sub-goal acquisition unit 350 generates the sub-goal request signals and, then sends them to the robots RA and RB, respectively (S22).

Once the robots RA and RB receive the sub-goal request signals, their controllers 40 call the sub-goal data from their memories 70. Subsequently, the controllers 40 send back the data to the robot controller 3 through the radio communicator 60 (S12, S32).

When the robot controller 3 receives the sub-goal data, the sub-goal acquisition unit 350 acquires this data. Following this, the collision possibility determination units 360 determine whether or not the robots RA and RB will collide with each other, based on this sub-goal data (S23).

The description will further continue, supposing that the robots RA and RB have been determined to collide.

Furthermore, the priority setting unit 370 assigns priority orders to the robots RA and RB (S24). The escape instruction sub-unit 391 of the moving route change instruction unit 390 decides an escape location for the lower priority robot RA. Furthermore, it generates the escape instruction signal containing the escape location data, and then, sends it to the robot RA through the I/O unit 100 (S25).

Once the lower priority robot RA receives the escape instruction signal, the controller 40 of the lower priority robot RA creates an escape route (S13). Subsequently, the lower priority robot RA moves toward the escape location, as well as its controller 40 generates an escape start notification signal and, then send it to the robot controller 3 through the radio communicator 60 (S14). When reaching the escape location, the lower priority robot RA stops moving there, and then wait until the higher priority robot RB avoids the robot RA itself (S15).

When the robot controller 3 receives the escape start notification signal, the avoidance instruction sub-unit 396 of the moving route change instruction unit 390 decides an avoidance location for the higher priority robot RB. Then, the sub-unit 396 generates the avoidance instruction signal containing the avoidance location, and then, sends it to the higher priority robot RB through the I/O unit 100 (S26).

Once the robot RB receives the avoidance instruction signal, its controller 40 creates an avoidance route (S33). Subsequently, the robot RB moves toward the avoidance location (S34). As soon as the robot RB reaches the avoidance location, its controller 40 generates an avoidance end notification signal and, then send it to the robot controller 3 through the radio communicator 60 (S35).

Upon receipt of this signal, the robot controller 3 finishes manipulating to prevent the robots RA and RB from colliding (S27).

<Main Flowchart of Robot Controller 3>

Next, a description will be given below, of a detailed operation of the robot controller 3.

First, the robot selection unit 310 selects two robots (the robots RA and RB) from all the robots R stored in the robot information database 210 (S101).

Subsequently, the robot selection unit 310 checks whether or not the robots RA and RB are contained in a collision avoidance list (S102).

If they are not in the list (“No” at S102), the current location acquisition unit 320 acquires the respective pieces of current location data of the robots RA and RB. Furthermore, the moving speed acquisition unit 330 acquires the respective pieces of moving speed data from the robots RA and RB. These pieces of data are outputted to the approach determination unit 340.

The approach determination unit 340 determines whether or not the robots RA and RB are approaching each other. When these robots are determined to be approaching, the sub-goal acquisition unit 350 generates respective pieces of sub-goal request signals of the robots RA and RB, and then, outputs them to the robots RA and RB. When the robot RA (or the robot RB) receives the signal, its controller 40 generates sub-goal data and, then sends it back to the robot controller 3. The sub-goal acquisition unit 350 acquires the sub-goal data and, then delivers it to the collision possibility determination unit 360. The unit 360 determines whether or not the robots RA and RB will collide with each other (S103).

If the robots RA and RB are determined to collide, then the combination of the robots RA and RB is added to the collision avoidance list (S104). The control system 300 sets up the state of the robots RA and RB in the collision avoidance list to “State 0” (S105).

Otherwise, if the robots RA and RB are determined not to collide at the step S103, then the operation returns to the step S101. The robot selection unit 310 selects a different combination, and two robots of the selected combination start operating.

The control system 300 checks the state of the robots RA and RB (S106). Subsequently, a downstream operation goes to individual steps, depending on the check result.

“State 0”

If the check result at the step S106 is “State 0”, then the sub-goal acquisition unit 350 generates the sub-goal request signals of the robots RA and RB and, then delivers them to the robots RA and RB, respectively, through the I/O unit 100 (S107). The control system 300 increments the state of the robots RA and RB to “State 1” (S108), and the operation returns to the step S101.

“State 1”

If the result at the step S106 is “State 1”, then the sub-goal acquisition unit 350 receives the respective pieces of sub-goal data from the robots RA and R (S109). Following this, the priority setting unit 370 assigns the priority orders to the robots RA and RB (S110). Subsequently, the escape instruction sub-unit 391 of the moving route change instruction unit 390 generates the escape instruction signal for the lower priority robot RA (S111), and then, delivers it to the lower priority robot RA through the I/O unit 100 (S112). The control system 300 increments the state of the robots RA and RB to “State 2” (S113), and the operation returns to the step S101.

If the sub-goal acquisition unit 350 does not receive the sub-goal data (“No” at S109), then the operation goes to the step S101, and the sub-goal acquisition unit 350 keeps waiting for the sub-goal data.

“State 2”

If the result at the step S106 is “State 2”, then the avoidance instruction sub-unit 396 of the moving route change instruction unit 390 receives the escape start notification signal from the lower priority robot RA. If the avoidance instruction sub-unit 396 receives the escape start notification signal (“Yes” at step S114), then it generates the avoidance instruction signal for the higher priority robot RB (S115). The avoidance instruction signal is delivered to the higher priority robot RB through the I/O unit 100 (S116). The control system 300 increments the state of the robots RA and RB to “State 3” (S117) and the operation returns to the step S101.

If the avoidance instruction sub-unit 396 does not receive the avoidance start notification signal (“No” at step S114), the operation returns to the step S101, and the unit 396 keep waiting for the avoidance start notification signal.

“State 3”

If the result at the step S106 is “State 3”, then the scenario reset instruction unit 400 checks whether or not the lower priority robot RA terminates the escape operation, and the robot distance (distance between robots) D is increasing (S118). Whether or not the escape operation is over is determined by comparing the escape location data and the current location data of the robot RA which is contained in the robot data being outputted at regular time intervals.

Alternatively, when the lower priority robot RA reaches the escape location, its controller 40 may generate the escape end notification signal. Furthermore, the scenario reset instruction unit 400 receives this signal, whereby it determines that the robot distance D is increasing

If the scenario reset instruction unit 400 determines that the lower priority robot RA stops the escape operation and the robot distance D is increasing (“yes” at S118), then the unit 400 generates the scenario reset instruction signal for the lower priority robot RA. The scenario reset instruction signal is delivered to the lower priority robot RA (S119). When receiving this signal, the lower priority robot RA re-executes the suspended task. The control system 300 increments the state of the robots RA and RB to “State 4” (S120), and the operation returns to the step S101.

Otherwise, if the control system 300 determines that the lower priority robot RA is still escaping or that the robot distance D is not increasing (“No” at S118), then the operation returns to the step S101.

“State 4”

If the result at the step S106 is “State 4”, then the scenario reset instruction unit 400 checks whether or not the higher priority robot RB finishes the avoidance operation (S120).

If the higher priority robot RB finishes this operation (“Yes” at S120), then the scenario reset instruction unit 400 generates the scenario reset instruction signal for the higher priority robot RB. The scenario reset instruction signal is delivered to the higher priority robot RB (S122). After that, the scenario reset instruction unit 400 deletes the combination of the robots RA and RB from the collision avoidance list (S123) and the operation returns to the step S101.

<Approaching Determination/Collision Possibility Determination>

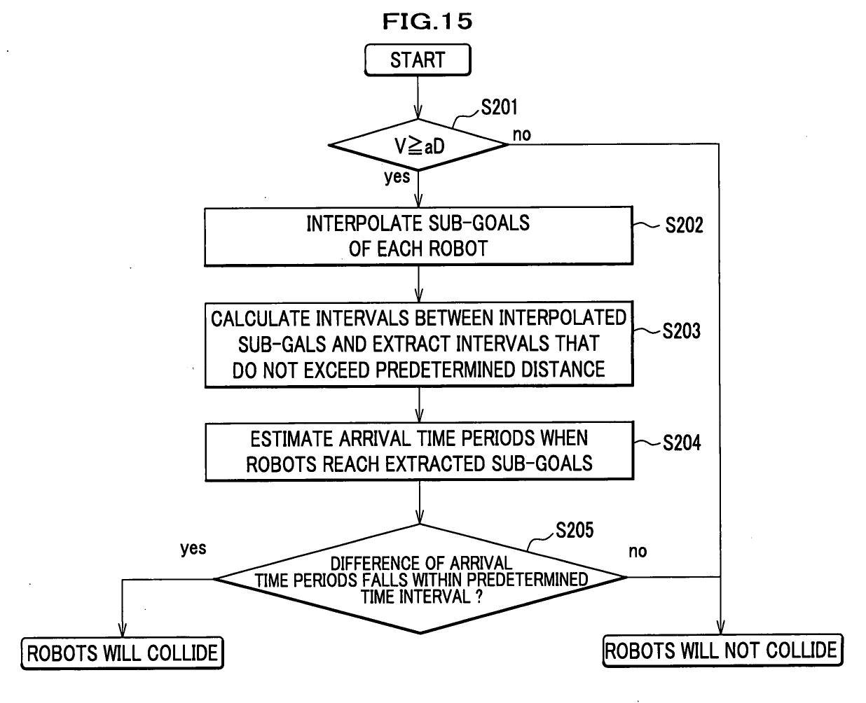

Now, a detailed description will be given below, of an approaching determination operation done by the approach determination unit 340 and of a collision possibility determination operation done by the collision possibility determination unit 360, with reference to FIG. 15.

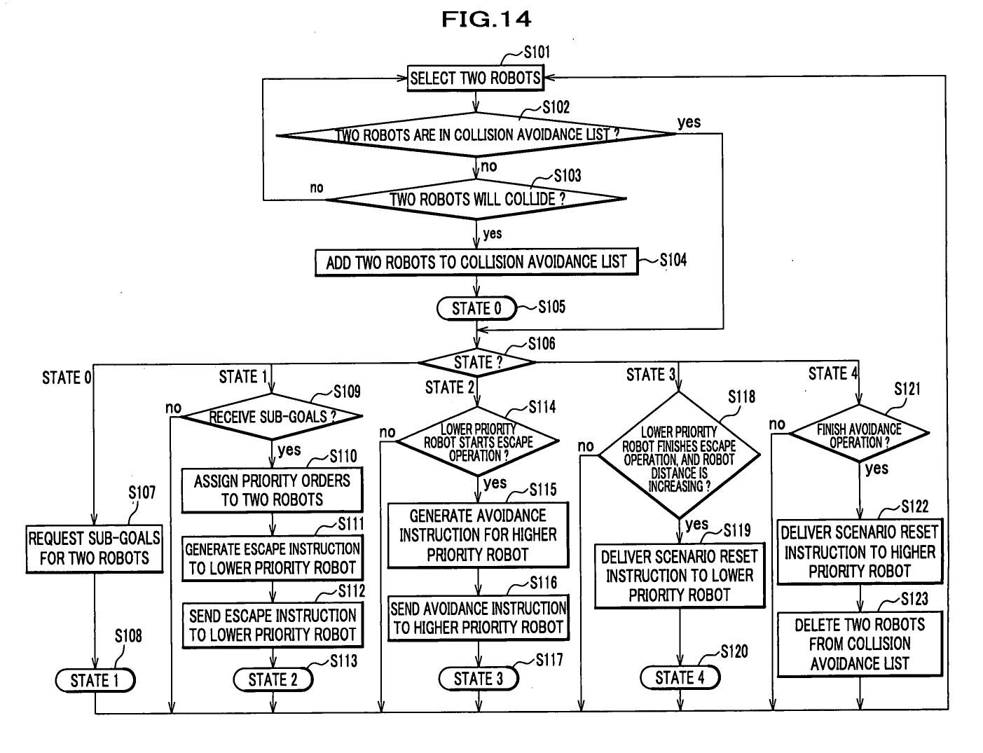

Referring to FIG. 15, steps S201 to S205 correspond to a subroutine of the flowchart in FIG. 14.

The approach determination unit 340 determines whether or not the robots RA and RB are approaching each other, on the basis of the current location data and the moving speed data of the robots RA and RB (S201).

If the relation of the robot approaching speed V and the robot distance D satisfies the relation (1) (“Yes” at S201), then the approach determination unit 340 determines that the robots RA and RB are approaching, and then, activates the sub-goal acquisition unit 350.

Otherwise, if the relation (1) is not satisfied (“No” at S201), then the approach determination unit 340 determines that the robots RA and RB are not approaching.

If the robots RA and RB are determined to be approaching, then the sub-goal interpolation sub-unit 361 of the collision possibility determination unit 360 interpolates the sub-goal data having been received from the robots RA and RB (S202).

The sub-goal interval computing sub-unit 363 calculates the distance between the respective sub-goals of the robots RA and RB. Following this, the sub-goal interval determination sub-unit 364 checks whether or not the calculated distance exceeds the predetermined distance “c”. Consequently, the combination of the sub-goals of which the distance does not exceed the distance “c” is created (S203).

The arrival time computing sub-unit 365 estimates the respective arrival time periods until the robots RA and RB reach the sub-goals of the created combination (S204).

The arrival time determine unit 366 determines whether or not a difference of the arrival time periods falls within a predetermined time interval “d” (S205).

If the difference is within the interval “d” (“Yes” at S205) then the collision possibility examination sub-unit 367 determines that the robots RA and RB may collide. This is because they will be very close to each other at a certain moment.

Otherwise, if the difference exceeds the interval “d” (“No” at S205), then sub-unit 367 determines that they will not collide. This is because the robots RA and RB reach a spot where they are closest to each other at different moments.

<Escape Location Estimation>

Now, a detailed description will be given below, of a determination of the escape location of the lower priority robot RA.

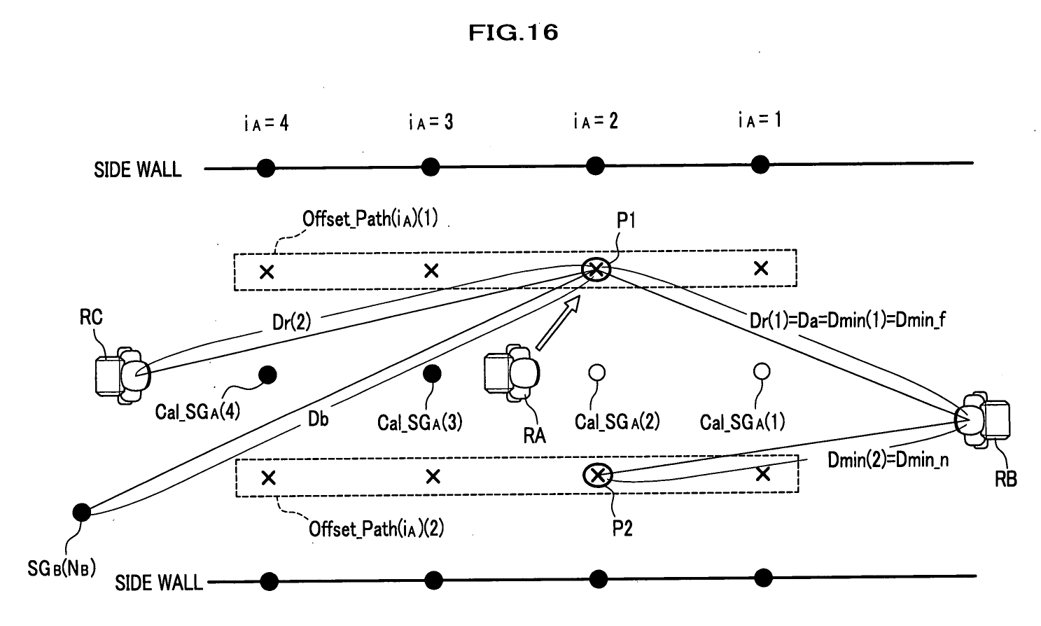

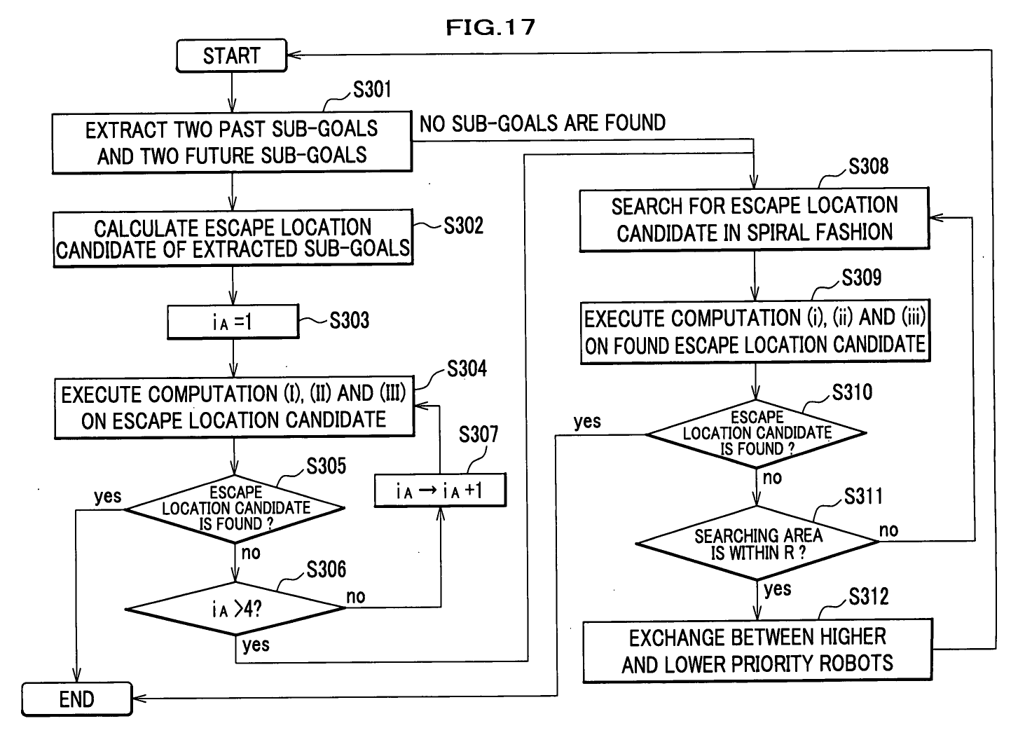

With reference to FIGS. 16 and 17, the description is given. Note that FIG. 17 shows a subroutine of the flowchart in FIG. 14. It is assumed that the lower priority robot RA has an N_{A} number of sub-goals. Furthermore, the n_{A}th sub-goal is defined as a point on two dimensional coordinates, and expressed as follow:
SG_{A}(n_{A}) (n_{A}=1, 2, . . . , N_{A}).
It is supposed that the robot RA is moving toward the m_{A}th sub-goal (SG_{A} (m_{A})). The escape location candidate generator 392a extracts two past sub-goals and two future sub-goals (S301). These four sub-goals are represented as follows:
Cal_{—}SG_{A}(i_{A}) (i_{A}=1, 2, 3, 4).
The specific extracted sub-goals Cal_SG_{A}(i_{A}) are as follows.
Cal_{—}SG_{A}(1)=SG(m_{A}+1) second future sub-goal
Cal_{—}SG_{A}(2)=SG(m_{A}) current sub-goal (first future) sub-goal
Cal_{—}SG_{A}(3)=SG(m_{A}−1) first past sub-goal
Cal_{—}SG_{A}(4)=SG(m_{A}−2) second past sub-goal

The escape location candidate generator 392a generates the pieces of escape location candidate data corresponding to the four sub-goals (S302).

In this case, the number of escape location candidates that correspond to the four sub-goals is two or four. This escape location candidate data is denoted as follows:
Offset_Path(i_{A}) (j_{A}) (i_{A}=1, 2, 3, 4, j_{A}=2 or 4).
One is selected among the two or four candidates, so that the escape location is decided.

Now, a description will be given below, of generating the pieces of escape location candidate data corresponding to the sub-goals in the case where:
(1) the number of candidates is two; and
(2) the number of candidates is four.

(1) Two Candidates

First, if the sub-goals (movable nodes) are arranged in a line on a hallway and the adjacent movable nodes are linked to each other, then the escape location candidate generator 392a creates two escape location candidates.

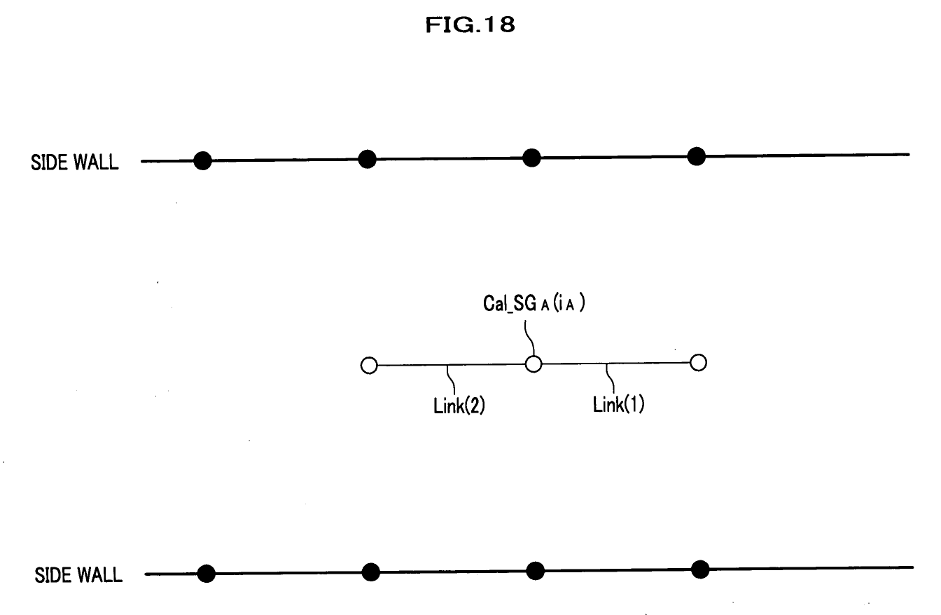

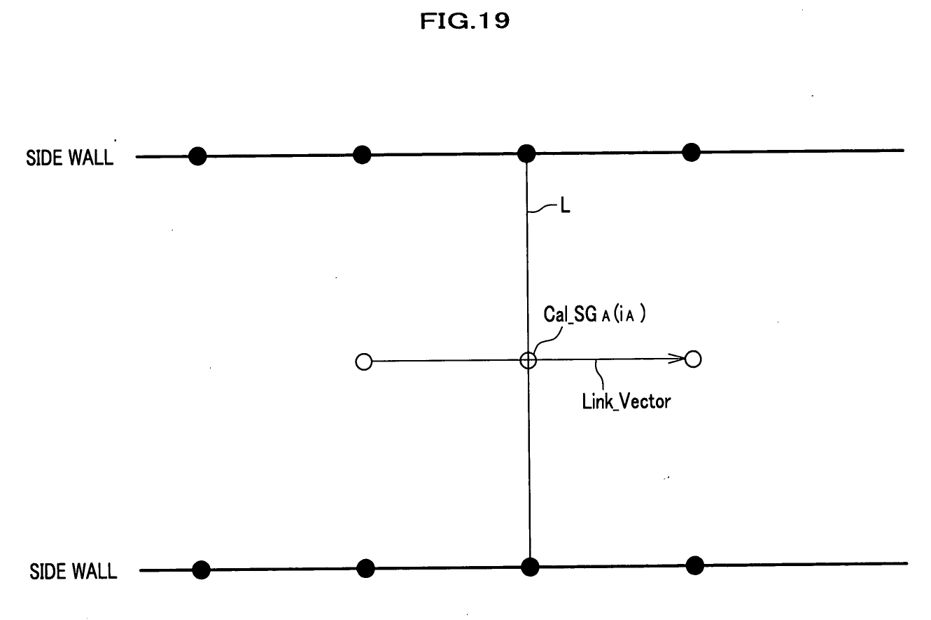

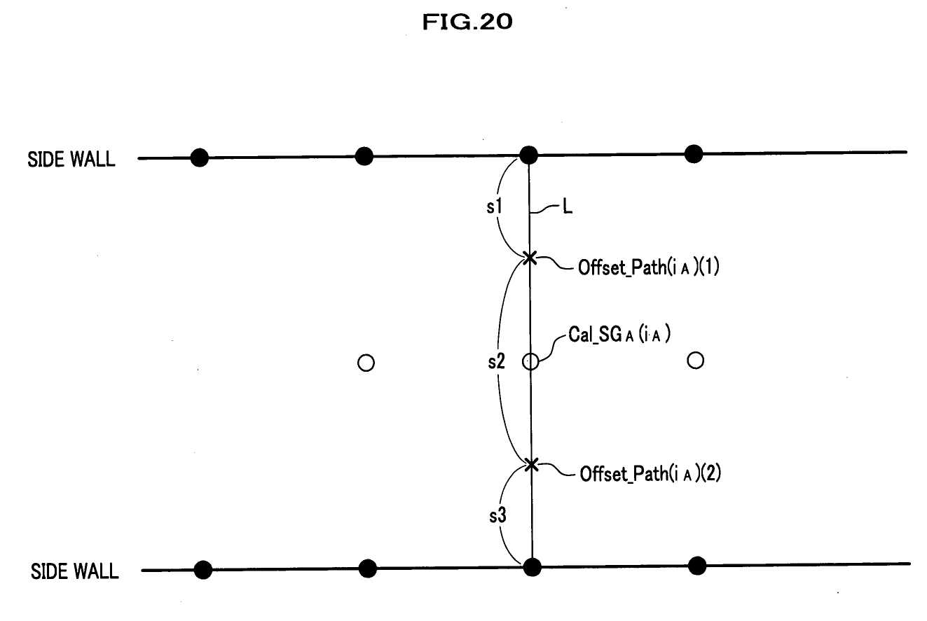

Referring to FIGS. 18 to 20, the description will continue. The generator 392a searches for the link between the sub-goal data Cal_SG_{A}(i_{A}). As shown in FIG. 18, two links, which are a link (1) and a link (2), are created between the sub-goal data Cal_SG_{A}(i_{A}). The link(1) and link(2) extend in series. As shown in FIG. 19, the escape location candidate generator 392a draws a straight line L perpendicular to a Link_Vector and passing through the sub-goal data Cal_SG_{A}(i_{A}). Following this, the generator 392a creates Offset_Path(i_{A}) (1) and Offset_Path(i_{A}) (2) as the pieces of escape location candidate data, as shown in FIG. 20. These pieces of data are created so as to ensure a minimum margin between the robots on the line L and a margin between the robot and a side wall. In this embodiment, two escape location candidates are established. The minimum margin between the robots corresponds to a distance enough to render the robots RA and RB pass each other without colliding. This margin is set beforehand on the basis of the size of the robot R. The margin between the robot and the side wall is denoted by a distance s1 between the wall and the escape location candidate data Offset_Path(i_{A}) (1) or a distance s2 between the wall and Offset_Path(i_{A}) (2). The distance s2 between the Offset_Path(i_{A}) (1) and the Offset_Path(i_{A}) (2) needs to be set to meet the minimum margin between the robots. If the side walls are considerably far away from each other, then the following relation may be established:
D=m/2,

wherein “D” is the distance between the sub-goal Cal_SG_{A}(i_{A}) and the escape location candidate Offset_Path(i_{A}) (1), and “m” is the minimum margin between the robots. It is obvious that the same relation be established for the escape location candidate Offset_Path(i_{A}) (2).

(2) Four Candidates

When a sub-goal (movable node) is positioned at crossroads, the escape location candidate generator 392a creates four escape location candidates.

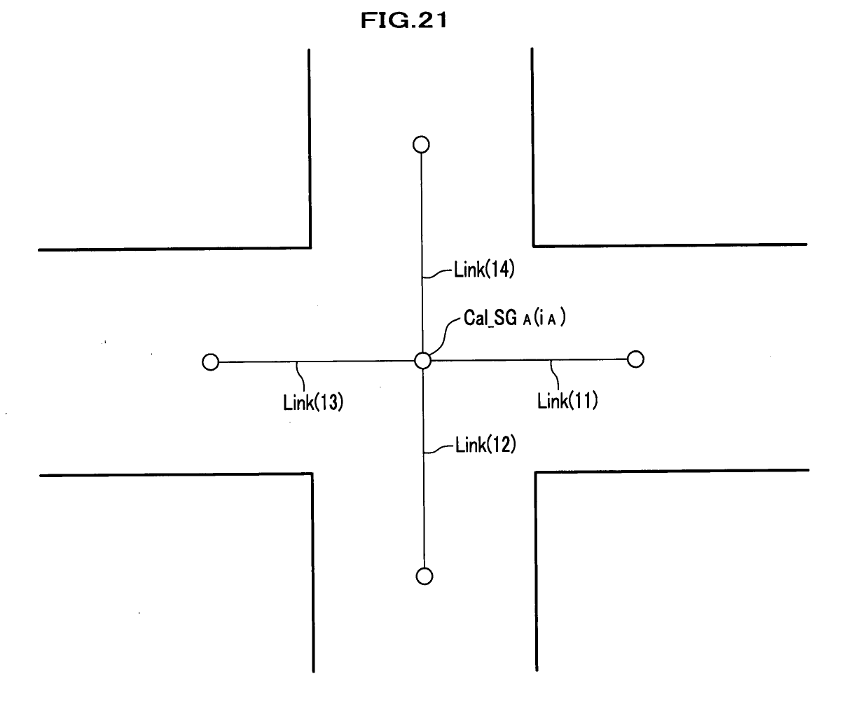

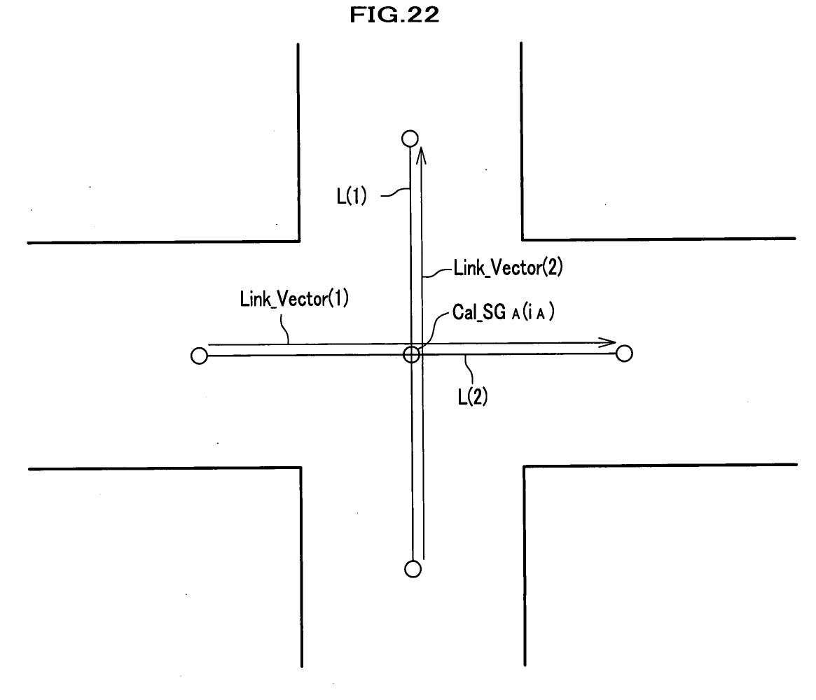

Referring to FIGS. 21 to 24, the description will continue. The escape location candidate generator 392a searches for links of the sub-goal data Cal_SG_{A}(i_{A}). As shown in FIG. 21, four links, which are link (11), link (12), link (13) and link (14), are created in relation to the sub-goal data Cal_SG_{A}(i_{A}). These links are arranged in a cross form. As shown in FIG. 22, the escape location candidate generator 392a draws two straight lines L(1) and L(2). The line L(1) is perpendicular to a Link_Vector(1) and passes through the sub-goal Cal_SG_{A}(i_{A}), while the line L(2) is perpendicular to Link_Vector(2) and passes through the sub-goal Cal_SG_{A}(i_{A}).

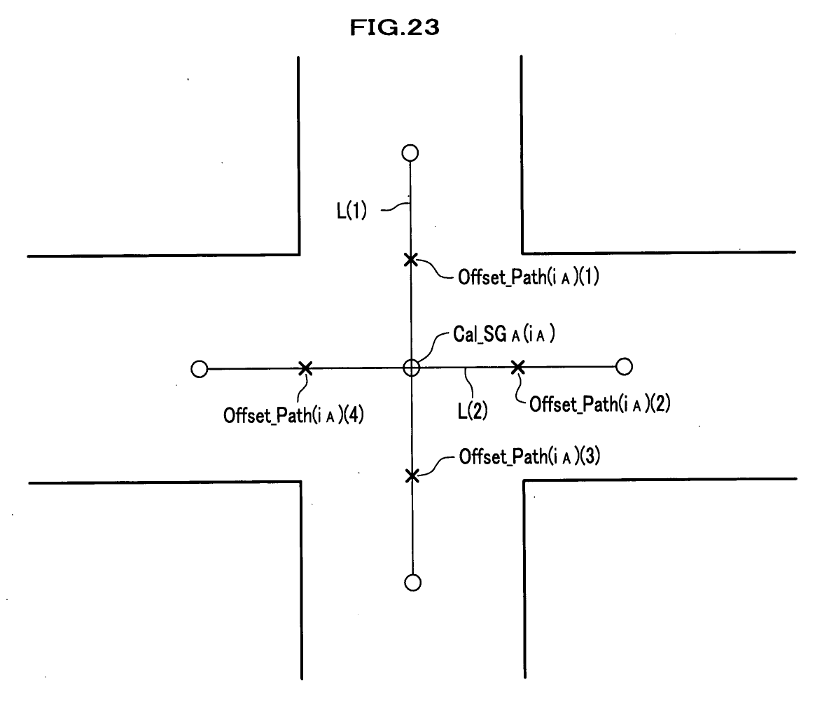

Next, as shown in FIG. 23, the escape location candidate generator 392a creates four pieces of escape location candidate data, Offset_Path(i_{A}) (1), Offset_Path(i_{A}) (2), Offset_Path(i_{A}) (3) and Offset_Path(i_{A}) (4). The Offset_Path(i_{A}) (1) and Offset_Path(i_{A}) (3) are arranged on the line (1), while the Offset_Path(i_{A}) (2) and Offset_Path(i_{A}) (4) are arranged on the line (2). All the pieces of data meet the minimum margins between the robots and between the side wall and the robot.

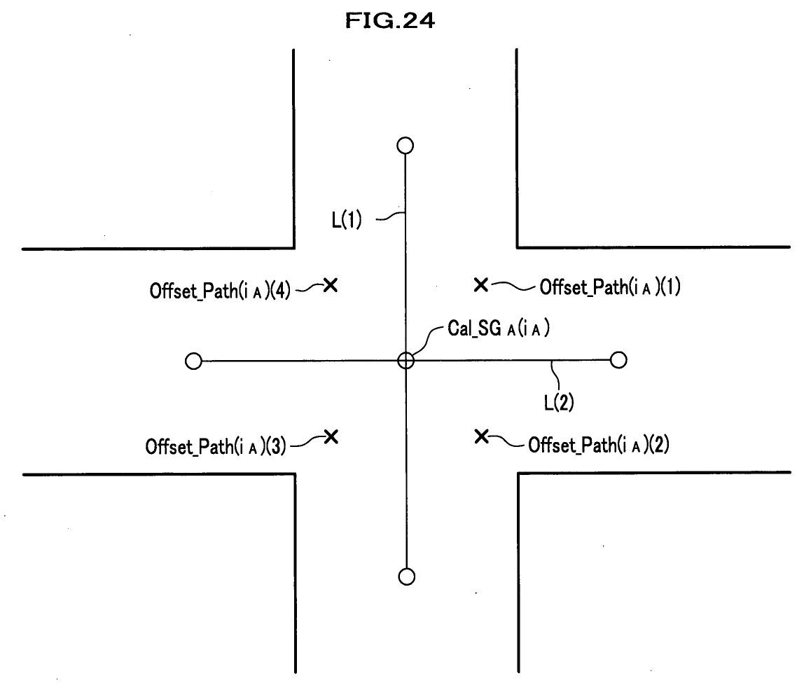

If the escape location candidates are positioned on a vector of anther link, then the escape location candidate generator 392a rotates all the escape location candidates around the sub-goal by a half of an angle which the vector forms. In this embodiment, the escape location candidates are rotated clockwise around the sub-goal Cal_SG_{A}(i_{A}) by an angle of 45 degrees, as shown in FIG. 24.

The escape location determiner 392b lets i_{A}=1 (S303). Subsequently, it carries out the computations (i) to (iii) in order to determine whether or not the escape location candidates are suitable for the escape location.

<Computation (i)>

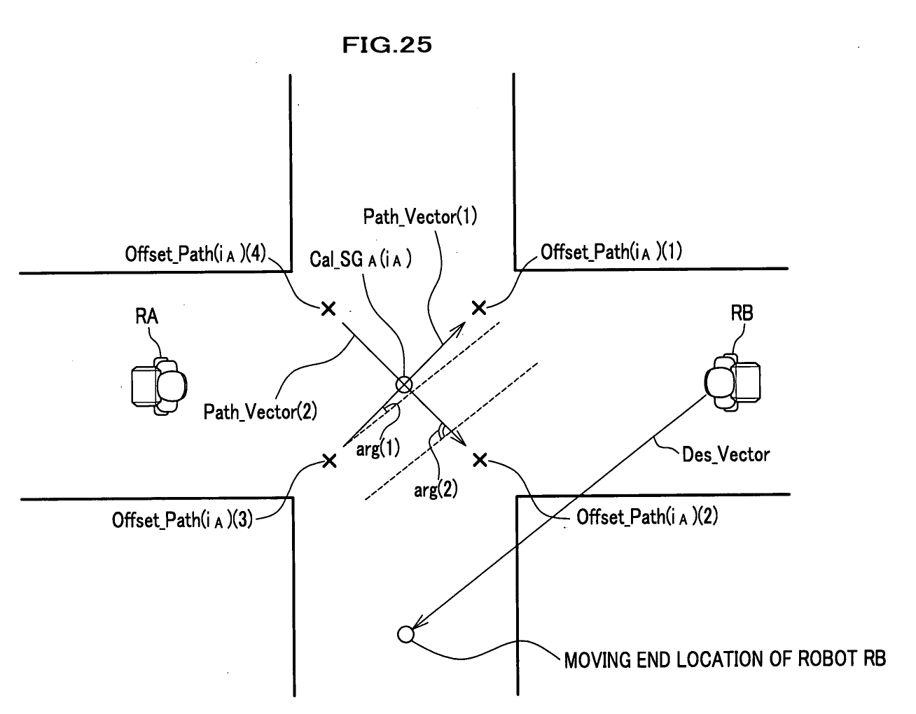

First, if the number of escape location candidates is four, then two out of the four candidates are focused. In this case, it can be considered that the sub-goal Cal_SG_{A}(i_{A}) is positioned at crossroads, as shown in FIG. 25.

Second, the escape location determiner 392b forms a vector coupling the current location of the higher priority robot RB to the moving end location thereof. This vector is defined as a Des_Vector.

Third, the escape location determiner 392b creates two vectors based on the four escape location candidates by coupling two points crossing each other. The two vectors are defined as a Path_Vector(1) and a Path_Vector(2), respectively. An angle which both the Des_Vector and the Path_Vector(1) form is denoted by an arg(1), and an angle which both the Des_Vector and the Path_Vector(2) form is denoted by an arg(2).

Finally, the escape location determiner 392b determines which of the arg(1) and the arg(2) is larger. Furthermore, the determiner 392b decides, as escape location candidates, the pieces of escape location candidate data which creates the vector forming the larger angle. In this embodiment, the escape location candidates are the Offset_Path(i_{A}) (2) and Offset_Path(i_{A}) (4).

Next, detailed escape and avoidance operations will be described in two cases where the four escape location candidates are rotated and not rotated.

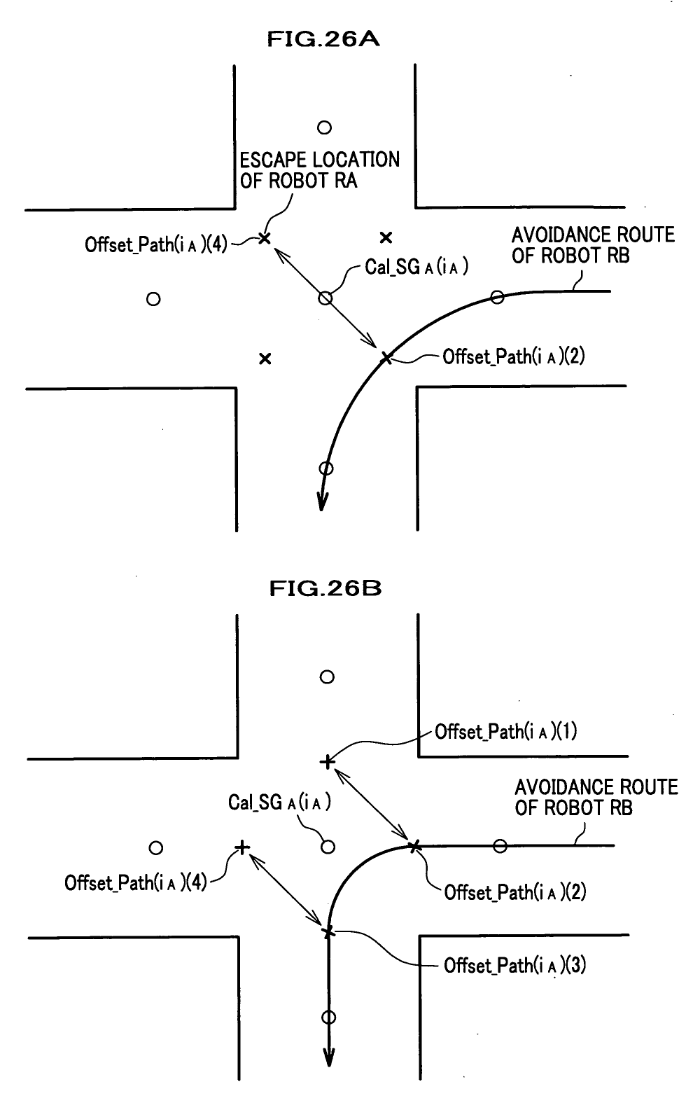

In the case of FIG. 26A, the escape location candidates are rotated. The lower priority robot RA escapes at the Offset_Path(i_{A}) (4), and the higher priority robot RB passes thorough the Offset_Path(i_{A}) (2) which is the avoidance transit location.

On the other hand, in the case of FIG. 26B, the escape location candidate is not rotated. The lower priority robot RA escapes at the Offset_Path(i_{A}) (1) or Offset_Path(i_{A}) (4). Subsequently, the higher priority robot RB passes through the Offset_Path(i_{A}) (2) and Offset_Path(i_{A}) (3), both of which are the avoidance transit locations.

As is cleared from the operations shown in FIGS. 26A and 26B, it is preferable that the four escape location candidates be rotated. This is because the longer distance between the robots RA and RB can be ensured, so that the robot RA and RS pass each other more appropriately.

<Computation (ii)>

The following computation on the two escape location candidates is performed.

First, the escape location determiner 392b calculates distances Da and Db. Both distances are denoted as follows:

Da=a minimum value of a distance between the escape location candidate and each of all the robots R positioned near the candidate; and

Db=a distance between the escape location candidate and the moving end location (goal) of the higher priority robot RB.

In the equation of Da, the term of “all the robots” means all the robots R positioned within an area and at equal to/less than a predetermined distance away from the escape location candidate, but the lower priority robot RA is excluded. Naturally, “all the robots” includes the higher priority robot RB. In this embodiment of FIG. 16, “all the robots” is represented by the higher priority robot RB and the robot RC.

In this figure, the distances Da and Db related to the escape location candidate data Offset_Paths (2) and (1) are shown. In this embodiment, the distance Dr(1) between the escape location candidate and the higher priority robot RB is shorter than the distance Dr(2) between the escape location candidate and the robot RC. Accordingly, the distance Dr(1) becomes the distance Da.

The escape location determiner 392b selects a smaller one among the distances Da and Db, and sets the selected one to Dmin (=Dmin(1)) related to the Offset_Paths(2) and (1). In this embodiment, the distance Da equals to Dmin (=Dmin(1)).

In addition, the escape location determiner 392b performs the similar computation on the escape location candidate data Offset_Paths (3) and (4). As a result, Dmin(=Dmin(2)) is determined.

<Computation (iii)>

The minimum distances Dmin corresponding to the escape location candidates are set to Dmin(1) and Dmin(2), respectively. Longer one among the minimum distances is a Dmin_f, and the other is a Dmin_n. The Dmin_f and Dmin_n are determined by the following equations:
Dmin_{—}f=Max(Dmin(1), Dmin(2)); and
Dmin_{—}n=Min(Dmin(1), Dmin(2)).
Furthermore, in this embodiment, the following relations are established:
Dmin_{—}f=Dmin(1); and
Dmin_{—}n=Dmin(2)
In addition,
Dmin_{—}f>(the minimum distance between the robots+the margin) (2)

If this relation is satisfied, then the escape location determiner 392b sets up the Dmin_f to an escape location, and the avoidance transit location generator 397a sets up the Dmin_n to an avoidance transit location (S305).

If the relation (2) is satisfied and the Dmin_f equals to the Dmin_n, then the escape location determiner 392b selects the candidate having larger Db as an escape location. Thus, the higher priority robot RB uses the candidate closer to the moving end location as an avoidance transit location. If the Db of the escape location candidates are equal, then the escape location determiner 392b selects the escape location candidate Dmin(1) as an escape location.

If the relation (2) is not satisfied, then the escape location determiner 392b determines there are no candidates satisfying the relation that i_{A} equals to 1. Then, the sub-unit 392 increments i_{A} by 1 (S307) and, then executes the operations of the escape location candidate Offset_Path (2) (j_{A}) at the steps S304 and S305.

In this embodiment, the escape location determiner 392b searches for the escape location candidate in the order in which i_{A} is incremented from 1 by 1. On finding the candidate, the searching step is over. The reason why the searching step starts from i_{A}=1 is that i_{A}=1 seems to be the most suitable for an escape location. This is because it is closest to the goal of the lower priority robot RA.

In this embodiment, the escape location determiner 392b sets up the escape location candidate data Offset_Path(2)(1) to the escape location P1, as shown in FIG. 16. In addition, the avoidance transit location generator 397a sets up the Offset_Path(2) (2) to the avoidance transit location P2. Furthermore, upon receipt of the scenario reset instruction signal, the higher priority robot RB starts executing the suspended task and, then heads for the sub-goal Cal_SG_{A}(1).

If an escape location is not found (“No” at S306), then the escape location candidate generator 392a uses the current location of the lower priority robot RA as an initial point, and then, searches for an escape location candidate in a spiral fashion. Once a candidate is found, the escape location candidate generator 392a and the escape location determiner 392b perform computations (i) to (iii) on this candidate. The searching step continues until the searching radius becomes a prescribed radius R.

Now, the spiral searching step will be described. The escape location candidate generator 392a uses the current location of the lower priority robot RA as an origin, and then, determines, on two dimensional coordinates:
x=(r+ft)sin(gt)
y=(r+ft)cos(gt),

wherein “t” is a real number and is not of a negative value, and “f”, “g” and “r” are individual constants.

The escape location candidate generator 392a and the escape location determiner 392b perform the above-described computation on a node (movable node) closest to the calculated x and y, and then, checks whether this node can be an escape location or not.

Nevertheless, if no escape location is found, the higher and lower priority robots are exchanged (S302), then the escape location candidate generator 392a and the escape location determiner 392b carry out the computation on the exchanged lower priority robot RB in order to determine an escape location.

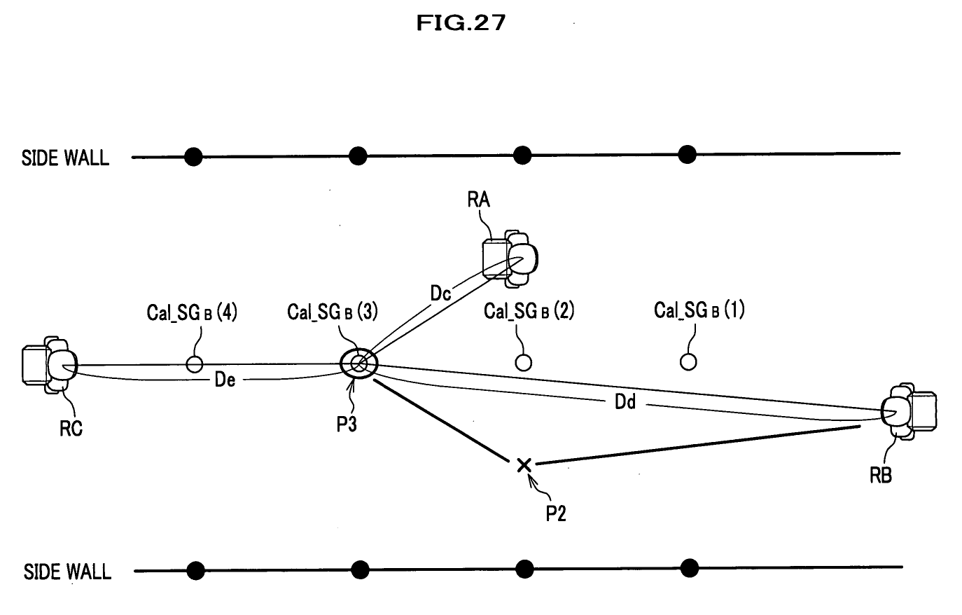

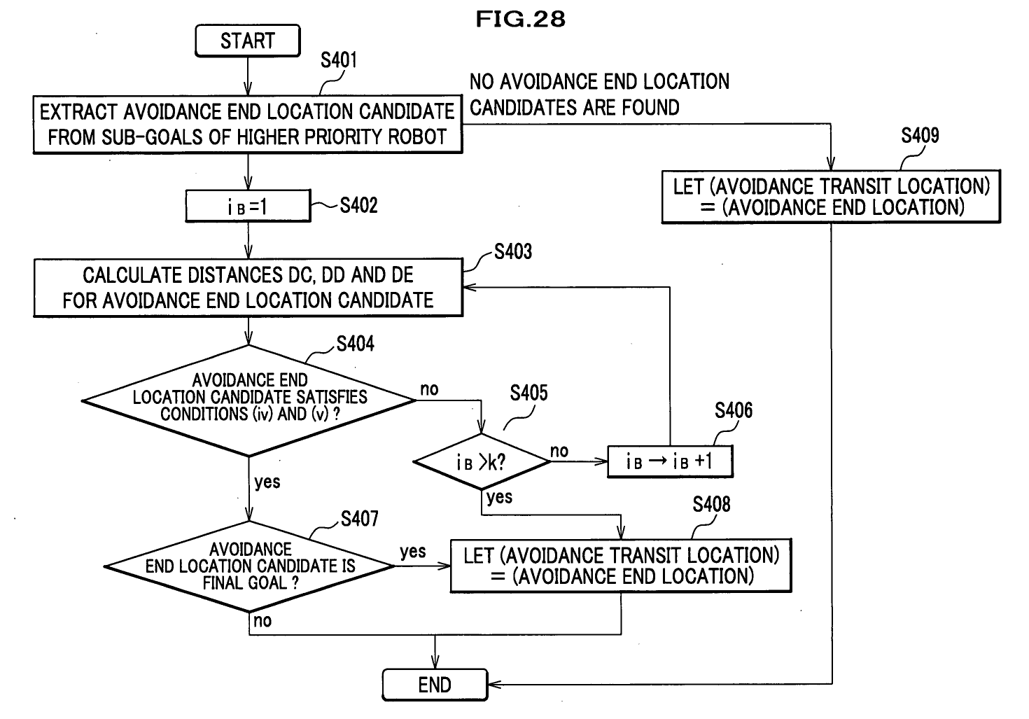

Next, a description will be given below, of how to determine an avoidance location of the higher priority robot RB, with reference to FIGS. 27 and 28. Steps S401 to S408 of FIG. 28 correspond to a subroutine of the step S115 in FIG. 14.

The avoidance operation of the higher priority robot RB includes the steps of determining the avoidance transit locations and the avoidance end location. The avoidance transit locations are created after the escape location of the lower priority robot RA is produced. The avoidance transit location generator 397a decides the avoidance transit locations by receiving the avoidance transit location data.

First, the avoidance end location generator 397b extracts avoidance end location candidates from the sub-goals of the higher priority robot RB (S401). It is assumed that the number of sub-goals which the higher priority robot RB has is N_{B}. The n_{B}th piece of sub-goal data is defined on two dimensional coordinates as follows:
SG_{B}(n_{B}) (n_{B}=1, 2, . . . , N_{B})

It is supposed that the higher priority robot RB is moving toward the m_{B}th sub-goal. In this case, the avoidance end location candidate data is denoted as follows:
Cal_{—}SG_{B}(i_{B}) (i_{B}=1, 2, . . . , k)
Moreover,
Cal_{—}SG_{B}(1)=SG(m_{B})
Cal_{—}SG_{B}(k)=SG(N_{B}) (k=N_{B}−m_{B}+1)

Thus, the number of avoidance end location candidate Cal_SG_{B}(i_{B}) is k, that is, NB−m_{B}+1.

Furthermore, the avoidance end location generator 397b lets i_{B}=1 (S402), distances Dc, Dd and De for the Cal_SG_{B}(1) are determined (S403).

Dc is defined by a distance between the avoidance end location candidate and the escape location of the lower priority robot;

Dd is defined by a distance between the avoidance end location candidate and the escape location of the higher priority robot; and

De is defined by a distance between the avoidance end location candidate and the escape location of another robot.

In this case, another robot includes all the robot except the robots RA and RB.

In FIG. 27, the distances Dc, Dd and De of the avoidance end location candidate data Cal_SG_{B}(3) are illustrated.

The avoidance end location generator 397b determines whether or not the avoidance end location candidate Cal_SG_{B}(i_{B}) satisfies the following relations (iv) and (v) (S404). (iv) If the avoidance end location candidate is not the moving end location (final goal) of the higher priority robot RB (i_{B}=k), which of the following relations are satisfied:
Dc>(the minimum distance between the robots+the margin); (3)
Dd>(a distance between the current locations of the lower priority robot RA and of the higher priority robot RB+the margin); and (4)
De>(a minimum distance between the robots). (5)

If the relation (3) is satisfied, then the avoidance end location is sufficiently away from the lower priority robot RA at the escape location.

If the relation (4) is satisfied, then the avoidance end location is positioned closer to the goal of the higher priority robot RB than the lower priority robot RA.

If the relation (5) is satisfied, then the avoidance end location is sufficiently away from other robots R including the lower priority robot RA. (v) If the avoidance end location candidate is a final goal (iB=k), which of the following relations are satisfied:
Dc>(the minimum distance between the robots+the margin); (6)
Dd>(the minimum distance between the robots+the margin); (7)
and
De>(the minimum distance between the robots+the margin). (3)

If the distances Dc, Dd and De meet these relations (6), (7) and (8), then the avoidance end location is not close to all the robots R other than the higher priority robot RB.

Unless these relations are satisfied, the avoidance end location generator 397 increments i_{B} by 1 (S406), and then, repeats the steps S403 and S404 until the avoidance end location candidate meets the above relations.

Once the relations are satisfied, the avoidance end location generator 397b determines whether or not the avoidance end location candidate is a final goal or not (S407). If this candidate is determined not to be a final goal, then the avoidance end location generator 397b sets up this candidate to the avoidance end location. Otherwise, if it is determined to be a final goal, then the generator 397b sets up the avoidance transit location to the avoidance end location (S408).

If the i_{B} does not meet all the relations (“No” at S405) then the avoidance end location generator 397b sets up the avoidance transit location to the avoidance end location (S408).

Furthermore, if the avoidance end location candidate cannot be extracted at the step S401, for example, due to the fact that the higher priority robot RB has no sub-goals, then the avoidance end location generator 397b sets up the avoidance transit location to the avoidance end location (S409).

In this embodiment, the avoidance end location generator 397b sets up the avoidance end location candidate data Cal_SG_{B}(3) to the avoidance end location P3, as shown in FIG. 27.

The robot controller 3 according to the embodiment of the present invention determines whether the robots R are approaching or not, and then, determines whether they may collide or not, in order to prevent the robots R from colliding. Specifically, the robot controller 3 normally monitors the state and the action plan (task) of each robot R. However, the robot controller 3 sends, to the robots, an instruction for preventing the collision, only as necessary. The robot controller 3 manipulates the robots R not to collide only when they are likely to collide. This enables the normal operation of the robots R not to be affected. In addition, the robot controller 3 assigns priority orders to the robots R, and allows them to do the escape or avoidance operation depending on these orders. This makes it possible to improve the task efficiency where the robot control system A controls all the robots.

As described above, the embodiment of the present invention has been described. However, the present invention is not limited to this embodiment. For example, the process for creating the autonomous mobile route (sub-goals) of the robots R is not limited to that in the embodiment. Alternatively, the robot controller 3 may create the sub-goals to send them to the robot R.

Furthermore, the above described components are not limited to specific configurations such as hardware, software or a combination thereof. These components may be implemented with any configurations as long as their functions can be achieved.

From the aforementioned explanation, those skilled in the art ascertain the essential characteristics of the present invention and can make the various modifications and variations to the present invention to adapt it to various usages and conditions without departing from the spirit and scope of the claims.

What is claimed is;

1. A robot controller for communicating with a plurality of mobile robots moving on their routes, comprising:
a map acquisition unit for obtaining map data on an active area where the routes are formed;
a current location acquisition unit for obtaining current location data on current locations of the robots;
a sub-goal acquisition unit for obtaining one or more pieces of sub-goal data on one or more sub-goals created on each of the routes;
a collision possibility determination unit for determining whether or not two robots out of the robots are likely to collide with each other, based on the sub-goal data;
a moving route change instruction unit for generating a moving route changing instruction signal, based on the map data, the current location data and the sub-goal data, the moving route changing instruction signal for allowing at least one of the two robots to change its route; and
a sending device for transmitting the moving route changing instruction signal to the corresponding one of the two robots,
wherein the robots are controlled such that they move around without causing collisions.

2. The robot controller according to claim 1, further comprising:
a moving speed acquisition unit for obtaining moving speed data on moving speeds of the robots; and
an approaching determination unit for determining whether or not two robots out of the plurality of robots are approaching each other, based on the current location data and the moving speed data,
wherein if the approaching determination unit determines that two robots out of the plurality of robots are approaching, then the collision possibility determination unit determines whether or not the two robots are likely to collide with each other.

3. The robot controller according to claim 2, further comprising a robot selection unit for selecting two robots from the plurality of robots,
wherein the current location acquisition unit obtains the current location data on the selected two robots,
wherein the moving speed acquisition unit obtains the moving speed data on the two robots, and
wherein the approaching determination unit determines whether or not the selected two robots are approaching each other, based on the current location data and the moving speed data.

4. The robot controller according to claim 2,
wherein if the approaching determination unit determines two robots out of the plurality of the robots are approaching each other, then the sub-goal acquisition unit obtains the sub-goal data on the two robots.

5. The robot controller according to claim 2,
wherein the collision possibility determination unit comprises:
a sub-goal selection sub-unit for selecting one piece from the pieces of sub-goal data on each of two robots;
a sub-goal interval computing sub-unit for estimating a distance between the selected pieces of the sub-goal data;
a sub-goal interval determination sub-unit for determining whether or not the estimated distance exceeds a predetermined distance;
an arrival time computing sub-unit for estimating time periods until the two robots reach their sub-goals, respectively, based on the selected pieces of sub-goal data;
an arrival time determination sub-unit for determining whether or not a difference between the estimated time periods fall within a predetermined time period; and
a collision possibility examination sub-unit for determining that the two robots are likely to collide with each other, if the sub-goal interval determination sub-unit determines that the estimated distance is equal to/less than the predetermined distance and the arrival time determination sub-unit determines that the difference is equal to/less than the predetermined time period.

6. The robot controller according to claim 5,
wherein if the sub-goal interval determination sub-unit determines that the estimated distance is equal to/less than the predetermined distance, then the arrival time computing sub-unit calculates time periods until the two robots reach the sub-goals, respectively.

7. The robot controller according to claim 5,
wherein the collision possibility determination unit further comprises a sub-goal interpolation sub-unit for creating one or more new pieces of sub-goal data between the adjacent pieces of sub-goals, based on the sub-goal data obtained by the sub-goal acquisition unit, and for outputting the new pieces of sub-goals to the sub-goal selection sub-unit.

8. The robot controller according to claim 1, further comprising a priority setting unit for setting up, among the two robots, one having a higher priority order to a higher priority robot and the other to a lower priority robot,
wherein the moving route change instruction unit generates a moving route changing instruction signal for allowing the lower priority robot to change its route so as not to collide with the higher priority robot.

9. The robot controller according to claim 8,
wherein the priority setting unit assigns the priority orders to the two robots, depending on tasks which the robots will execute.

10. The robot controller according to claim 8,
wherein the moving route change instruction unit comprises:
an escape instruction sub-unit for generating an escape instruction signal for allowing the lower priority robot to change the route so that the lower priority robot moves to an escape location, thereby escaping from the higher priority robot, and the escape instruction signal is included in the moving route changing instruction signal; and
an avoidance instruction unit for generating an avoidance instruction signal for allowing the higher priority robot to change the route so that the higher priority robot moves while avoiding the lower priority robot staying at the escape location, and the avoidance instruction signal is included in the moving route changing instruction signal.

11. The robot controller according to claim 10,
wherein the escape instruction sub-unit comprises:
an escape location generation sub-unit for generating escape location data on the escape location of the lower priority robot, based on the map data and the sub-goal data; and
an escape instruction generation sub-unit for generating the escape instruction signal for allowing the lower priority robot to move to the escape location, based on the escape location data, and
wherein the avoidance instruction unit comprises:
an avoidance location generation sub-unit for generating avoidance location data on an avoidance location where the higher priority robot will escape, based on the escape location data on the escape location, the map data and the sub-goal data, and
an avoidance instruction generation sub-unit for generating the avoidance instruction signal for allowing the higher priority robot to move to the avoidance location, based on the avoidance location data.

12. The robot controller according to claim 11,
wherein the avoidance location generation sub-unit comprises:
an avoidance transit location generator for generating avoidance transit location data on one or more avoidance transit locations where the higher priority robot passes while avoiding lower priority robot staying at the escape location, based on the map data and the escape location data; and
an avoidance end location generator for generating escape end location data on an avoidance end location through which the higher priority robot passes, before returning to the route,
wherein the avoidance instruction generation sub-unit generates the avoidance instruction signal for allowing the higher priority robot to move to the avoidance end location by way of the avoidance transit locations, based on the avoidance transit location data and the escape end location data.

13. The robot controller according to claim 12,
wherein the escape location generation sub-unit comprises:
an escape location candidate generator for generating escape location candidate data on one or more escape location candidates for the sub-goal, based on the current location data, the sub-goal data and the map data, and
an escape location determiner for selecting the escape location from the escape location candidates, based on the escape location candidate data and the current location data.

14. The robot controller according to claim 13,
wherein the avoidance transit location generator selects the avoidance transit locations from the escape location candidates which the escape location determiner has not selected.

15. A robot control system, comprising:
a plurality of mobile robots for moving within an active area;
a base station being connected to the robots through radio communication;
the robot controller according to claim 1 being connected to the base station;
a network; and
one or more terminals connected to the robot controller through the network.

16. A process for controlling a plurality of mobile robots moving on their routes by using a robot controller in such a way that the robots do not collide with one another, the robot controller communicating with the robots, the process comprising:
obtaining map data on an active area where the routes are formed;
obtaining current location data on current locations of the robots;
obtaining one or more pieces of sub-goal data on one or more sub-goals created on each of the routes;
determining whether or not two robots out of the robots are likely to collide with each other, based on the sub-goal data;
generating a moving route changing instruction signal, based on the map data, the current location data and the sub-goal data, the moving route changing instruction signal for allowing at least one of the two robots to change its route; and
transmitting the moving route changing instruction signal to the corresponding one of the two robots.

17. The process according to claim 16, further comprising:
obtaining moving speed data on moving speeds of the robots; and
determining whether or not two robots out of the plurality of robots are approaching each other, based on the current location data and the moving speed data,
wherein the determination whether or not the two robots are likely to collide with each other is made, if two robots out of the plurality of robots are determined to be approaching.

18. The process according to claim 17, further comprising selecting two robots from the plurality of robots,
wherein the obtained current location data concerns the selected two robots,
wherein the obtained moving speed data concerns the selected two robots, and
wherein the robots which are determined by whether to be approaching each other are the selected two robots.
